(19) United States
(12) Patent Application Publication
(10) Pub. No.: US 2026/0349325 A1
(43) Pub. Date: Nov. 5, 2026

(54) PROJECTION SCREEN AND PROJECTION SYSTEM

(71) Applicant: HISENSE LASER DISPLAY CO., LTD., Shandong (CN)

(72) Inventors: Yoshihiro OSHIMA, Shandong (CN); Akira TASHIRO, Shandong (CN); Junichi OSAKO, Shandong (CN); Nobuo NAITO, Shandong (CN); Hayashi MASATAKE, Shandong (CN); Nakagome KEISUKE, Shandong (CN); Rui HOU, Shandong (CN)

(21) Appl. No.: 19/075,113

(22) Filed: Mar. 10, 2025

Related U.S. Application Data
(63) Continuation of application No. PCT/CN2024/081257, filed on Mar. 12, 2024.

(30) Foreign Application Priority Data
Apr. 19, 2023 (CN) 202310422256.0
May 16, 2023 (CN) 202310548405.8
Aug. 25, 2023 (CN) 202311078929.1
Nov. 2, 2023 (CN) 202311449292.2

(51) Int. Cl. G03B 21/60; G03B 21/20

(52) U.S. Cl. CPC G03B 21/60; G03B 21/2013; G03B 21/2033

(57) ABSTRACT

Provided in the embodiments of the present disclosure are a projection screen and a projection system. The projection screen includes: a surface functional layer, a Fresnel lens layer and a reflecting layer, wherein the Fresnel lens layer includes a plurality of lens units, and the reflecting layer is at least located on lens surfaces of the lens units. The projection screen provided in the embodiments of the present disclosure can achieve effects such as improving the black luminance of the projection screen by absorbing incident ambient light, increasing the contrast of a projected image by selectively reflecting incident projection light while absorbing light of other wavebands, and improving the gain uniformity of the projection screen.

### CROSS REFERENCE TO RELATED APPLICATION

This application is a continuation of International Application No. PCT/CN2024/081257, filed on Mar. 12, 2024, which claims priorities to Chinese Patent Application No. 202310422256.0, filed with the China National Intellectual Property Administration on Apr. 19, 2023 and entitled “PROJECTION SCREEN, MANUFACTURING METHOD THEREOF AND PROJECTION SYSTEM”, Chinese Patent Application No. 202310548405.8, filed with filed with the China National Intellectual Property Administration on May 16, 2023 and entitled “PROJECTION SCREEN AND PROJECTION SYSTEM”, Chinese Patent Application No. 202311078929.1, filed with the China National Intellectual Property Administration on Aug. 25, 2023 and entitled “PROJECTION SCREEN AND PROJECTION SYSTEM”, and Chinese Patent Application No. 202311449292.2, filed with the China National Intellectual Property Administration on Nov. 2, 2023 and entitled “MANUFACTURING METHOD OF PROJECTION SCREEN”, all of which are incorporated by reference in their entireties.

### TECHNICAL FIELD

The present disclosure relates to the field of projection technology, and in particular to a projection screen and a projection system.

### BACKGROUND

As display products continue to grow in size, the market for projection display products as large-screen products that replace LCD and organic electroluminescent (EL) TVs is rapidly expanding in consideration of power consumption, weight, and size. Laser TVs that use ultra-short-throw projection device are developing rapidly because of their high image quality and large screen convenience.

The current projection system can usually be used in conjunction with a projection screen. The projection device emits projection light, and the projection light is incident on the projection screen and then reflected by the projection screen to the human eye, where the projected image is viewed. A Fresnel lens layer is provided inside the projection screen to reflect the projection light emitted by the projection device toward the audience.

### SUMMARY

In a first aspect, embodiments of the present disclosure provide a projection screen, including:
a surface functional layer;
a Fresnel lens layer, located on a side of the surface functional layer; where the Fresnel lens layer includes a plurality of lens units, the plurality of lens units are arranged in concentric arcs that expand in sequence along a radial direction; the lens units include lens surfaces tilted relative to a plane where the surface functional layer is located; and
a reflection layer, at least covering the lens surfaces of the lens units;
where an inclination angle of the lens surface of each of the lens units is sufficient to reflect light, emitted by a projection device to the reflection layer on the lens surface, toward a viewer;
each of the lens units is axially symmetrically distributed, a symmetry axis of each of the lens units is perpendicular to a horizontal direction, and circle centers of the lens units are located on a straight line where the symmetry axis is located; the inclination angle of the lens surface of at least one lens unit in the plurality of lens units at a first location is greater than the inclination angle at a second location, and a distance from the first location to the symmetry axis is greater than a distance from the second location to the symmetry axis.

In a second aspect, embodiments of the present disclosure provide a projection system, including:
a projection device for emitting projection light; and
a projection screen, located on a light-emitting side of the projection device; where the projection screen is the above projection screen;
where the projection device is an ultra-short-throw laser projection device; the projection device includes:
a three-color laser source device, used for emitting three-primary-color laser lights;
a light modulation component, located on a light-emitting side of the three-color laser source device, and used to modulate a laser light emitted by the three-color laser source device; and
a projection lens, located on a light-emitting side of the light modulation component.

### BRIEF DESCRIPTION OF FIGURES

FIG. 1 is a schematic diagram of a structure of a projection system provided by embodiments of the present disclosure.

FIG. 2 is a first schematic diagram of a cross-sectional structure of a projection screen in the related art.

FIG. 3 is a first schematic diagram of a projection effect provided by embodiments of the present disclosure.

FIG. 4 is a schematic diagram of partitions of a projection screen provided by embodiments of the present disclosure.

FIG. 5 is a first schematic diagram of a cross-sectional structure of a projection screen provided by embodiments of the present disclosure.

FIG. 6 is a first schematic diagram of a planar structure of a Fresnel lens layer provided by embodiments of the present disclosure.

FIG. 7 is a second schematic diagram of a projection effect provided by embodiments of the present disclosure.

FIG. 8 is a first curve showing variation of an inclination angle of an inclined face of a Fresnel structure at a different location provided by embodiments of the present disclosure.

FIG. 9 is a schematic diagram of a cross-sectional structure of a projection screen along a symmetry axis I-I′ in FIG. 6.

FIG. 10 is a second curve showing variation of an inclination angle of an inclined face of a Fresnel structure at a different location provided by embodiments of the present disclosure.

FIG. 11 is a second schematic diagram of a cross-sectional structure of a projection screen provided by embodiments of the present disclosure.

FIG. 12 is a third schematic diagram of a cross-sectional structure of a projection screen provided by embodiments of the present disclosure.

FIG. 13 is a fourth schematic diagram of a cross-sectional structure of a projection screen provided by embodiments of the present disclosure.

FIG. 14 is a schematic diagram of a planar structure of a surface functional layer provided by embodiments of the present disclosure.

FIG. 15 is a fifth schematic diagram of a cross-sectional structure of a projection screen provided by embodiments of the present disclosure.

FIG. 16 is a sixth schematic diagram of a cross-sectional structure of a projection screen provided by embodiments of the present disclosure.

FIG. 17 is a seventh schematic diagram of a cross-sectional structure of a projection screen provided by embodiments of the present disclosure.

FIG. 18 is an eighth schematic diagram of a cross-sectional structure of a projection screen provided by embodiments of the present disclosure.

FIG. 19 is a ninth schematic diagram of a cross-sectional structure of a projection screen provided by embodiments of the present disclosure.

FIG. 20 is a tenth schematic diagram of a cross-sectional structure of a projection screen provided by embodiments of the present disclosure.

FIG. 21 is a first schematic diagram of a structure of a wavelength selection based reflection layer provided by embodiments of the present disclosure.

FIG. 22 is a second schematic diagram of a structure of a wavelength selection based reflection layer provided by embodiments of the present disclosure.

FIG. 23 is a third schematic diagram of a structure of a wavelength selection based reflection layer provided by embodiments of the present disclosure.

FIG. 24 is a reflectivity curve of a wavelength selection based reflection layer to light of different wavelength bands provided by embodiments of the present disclosure.

FIG. 25 is a schematic diagram of an optical path of projection light incident on a projection screen provided by embodiments of the present disclosure.

FIG. 26 is a first schematic diagram of coating provided by embodiments of the present disclosure.

FIG. 27 is a reflectivity curve of a wavelength selection based reflection layer produced by a wavelength shift provided by embodiments of the present disclosure.

FIG. 28 is a second schematic diagram of coating provided by embodiments of the present disclosure.

FIG. 29 is a curve showing changes in optical parameters of a metal complete oxide provided by embodiments of the present disclosure.

FIG. 30 is a curve showing changes in optical parameters of a metal low-valent oxide provided by embodiments of the present disclosure.

FIG. 31 is a curve showing the change of oxidation number with the flow rate of reactive gas in the reactive sputtering process of plasma luminescence control provided by embodiments of the present disclosure.

FIG. 32 is a curve showing the change of oxygen partial pressure with the flow rate of reactive gas in the reactive sputtering process of plasma luminescence control provided by embodiments of the present disclosure.

FIG. 33 is a curve showing the variation of the extinction coefficient with the reactive gas flow rate in the reactive sputtering process of plasma luminescence control provided by embodiments of the present disclosure.

FIG. 34 is a curve showing the change of film forming speed with the change of reactive gas flow rate in the reactive sputtering process controlled by plasma luminescence provided by embodiments of the present disclosure.

FIG. 35 is a schematic diagram of a structure of a projection device provided by embodiments of the present disclosure.

FIG. 36 is a flowchart of a method for manufacturing a projection screen provided by embodiments of the present disclosure.

FIG. 37 is a schematic structural diagram of a film-forming cathode portion of a sputtering device in the related art.

FIG. 38 is a schematic structural diagram of a film-forming cathode portion of a sputtering device provided by embodiments of the present disclosure.

FIG. 39 is a schematic diagram of a sputtering process provided by embodiments of the present disclosure.

FIG. 40 is a second schematic diagram of a planar structure of a Fresnel lens layer provided by embodiments of the present disclosure.

FIG. 41 is a schematic diagram of a cross-sectional structure along an A-A′ direction in FIG. 40.

FIG. 42 is a second flowchart of a method for manufacturing a projection screen provided by embodiments of the present disclosure.

FIG. 43 is a schematic diagram of a cross-sectional structure of a locational relationship between an evaporation source and a Fresnel lens layer provided by embodiments of the present disclosure.

FIG. 44 is a first schematic diagram of a planar structure of a locational relationship between an evaporation source and a Fresnel lens layer provided by embodiments of the present disclosure.

FIG. 45 is a second schematic diagram of a planar structure of a locational relationship between an evaporation source and a Fresnel lens layer provided by embodiments of the present disclosure.

FIG. 46 is a schematic diagram of a cross-sectional structure along an I-I′ direction in FIG. 44.

FIG. 47 is a schematic cross-sectional view showing a locational relationship among an evaporation source, a baffle and a Fresnel lens layer provided by embodiments of the present disclosure.

FIG. 48 is a schematic diagram of a planar structure of a locational relationship between a baffle and a Fresnel lens layer provided by embodiments of the present disclosure.

FIG. 49 is a second schematic diagram of a cross-sectional structure of a locational relationship among an evaporation source, a baffle and a Fresnel lens layer provided by embodiments of the present disclosure.

FIG. 50 is a first schematic diagram of a planar structure of a locational relationship among an evaporation source, a baffle and a Fresnel lens layer provided by embodiments of the present disclosure.

FIG. 51 is a second schematic diagram of a planar structure of a locational relationship among an evaporation source, a baffle and a Fresnel lens layer provided by embodiments of the present disclosure.

FIG. 52 is a third schematic diagram of a cross-sectional structure of a locational relationship among an evaporation source, a baffle and a Fresnel lens layer provided by embodiments of the present disclosure.

FIG. 53 is a schematic diagram of a cross-sectional structure along a B-B′ direction in FIG. 40.

FIG. 54 is a schematic diagram showing a locational relationship among an evaporation source, a baffle and a Fresnel lens layer along a cross section shown in FIG. 53.

FIG. 55 is a third schematic diagram of a planar structure of an evaporation source, a baffle and a Fresnel lens layer provided by embodiments of the present disclosure.

FIG. 56 is a fourth schematic diagram of a planar structure of an evaporation source, a baffle and a Fresnel lens layer provided by embodiments of the present disclosure.

FIG. 57 is a schematic diagram of a planar structure of an evaporation source, a baffle and a lens structure layer provided by embodiments of the present disclosure.

### DETAILED DESCRIPTION

In order to make the features and advantages of the present disclosure more obvious and easy to understand, the present disclosure will be further described below in conjunction with the drawings and embodiments. However, the embodiments can be implemented in various forms and should not be construed as being limited to the embodiments described herein; on the contrary, these embodiments are provided to make the present disclosure more comprehensive and complete, and to fully convey the concepts of the embodiments to those skilled in the art. The same figure marks in the figures represent the same or similar structures, and thus their repeated descriptions will be omitted. The words expressing location and direction described in the present disclosure are all explained using the drawings as examples, but changes can be made as needed, and all changes are included in the scope of protection of the present disclosure. The drawings of the present disclosure are only used to illustrate the relative location relationship and do not represent the true proportions.

With the popularity of laser display products, the market for laser TVs has expanded rapidly as a large-screen product to replace LCD and organic EL TVs. In order to achieve better brightness and display effects, projection device is generally used with a projection screen.

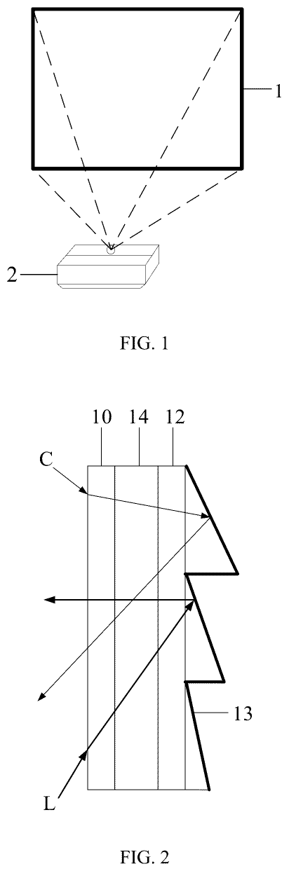

FIG. 1 is a schematic diagram of a structure of a projection system provided by embodiments of the present disclosure.

As shown in FIG. 1, the projection system includes: a projection device 2 and a projection screen 1.

The projection screen 1 is located on a light-emitting side of the projection device 2. The audience faces the projection screen 1. The projection device 2 emits projection light. The projection light is incident on the projection screen 1 and is emitted to the location of the audience through the projection screen 1, so that the audience can watch the projected image.

When the projection device 2 and the audience are located on the same side of the projection screen 1, the projection system is a front projection system. When the projection device 2 and the audience are located on both sides of the projection screen 1, the projection system is a rear projection system. In the front projection system, the projection device 2 emits projection light to the projection screen 1, and the projection screen 1 reflects the projection light to the audience, so that the audience can watch the projected image. In the rear projection system, the projection device 2 emits projection light to the projection screen 1, and the projection light is emitted to the audience through the projection screen 1, so that the audience can watch the projected image.

The ultra-short-throw projection device has the characteristics of short projection distance and large projection screen, and is very suitable for application in the home field. The projection system provided in the embodiments of the present disclosure can adopt the ultra-short-throw projection device. The embodiments of the present disclosure take the front-projection ultra-short-throw projection system as an example to specifically illustrate the structure of the projection screen. The front-projection ultra-short-throw projection system usually installs the projection screen 1 on the wall or hangs the projection screen 1 at a high place. The projection device 2 is located below the projection screen 1, and the projection light is emitted from the bottom of the projection screen 1 to the projection screen 1 obliquely upward. Since the ultra-short-throw projection system has a small projection ratio, a larger-sized projection image can be obtained while reducing the distance between the projection device 2 and the projection screen 1, which is very suitable for application in scenes such as laser TVs.

FIG. 2 is a first schematic diagram of a structure of a projection screen in the related art.

As shown in FIG. 2, the projection screen includes: a surface layer 10, a Fresnel lens layer 12 and a reflection layer 13, where the surface layer 10 and the Fresnel lens layer 12 are bonded to each other via an binding layer 14, the Fresnel lens layer 12 includes a plurality of lens units, and the respective lens units are arranged in concentric arcs that expand in sequence along a radial direction. The surface of the lens unit is provided with the reflection layer 13, and the lens unit can make the light L emitted by the projection device 1 enter the reflection layer 13 on the surface of the Fresnel lens layer 12 and then reflect toward the location where the audience is located, so that the projection light enters the human eye and the projection image is viewed.

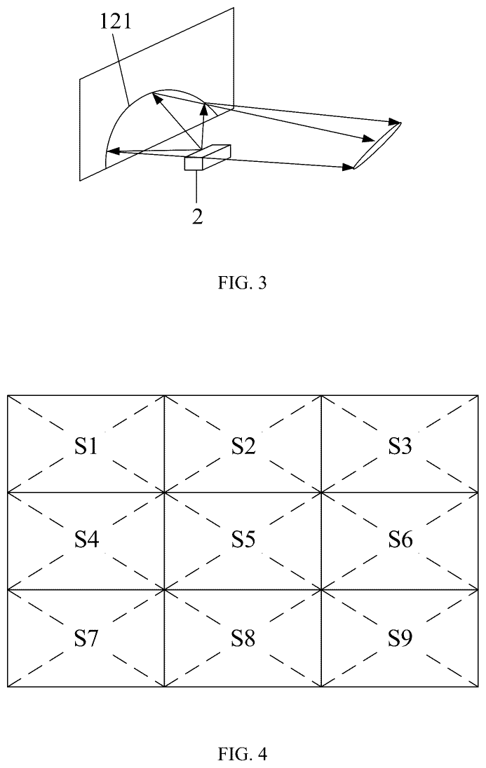

FIG. 3 is a first schematic diagram of a projection effect provided by embodiments of the present disclosure.

For ease of explanation, only one lens unit 121 is shown in FIG. 3. In actual applications, each lens unit 121 has the same problem. Since the lens unit 121 is usually a spherical mirror, that is, the same lens unit 121 is located on a spherical mirror with the same radius of curvature, and the spherical mirror itself has astigmatism, as shown in FIG. 3, the lens unit 121 cannot reflect the incident light to the same location, and the light collection effect is poor, thereby causing the gain uniformity of the projection screen to deteriorate.

FIG. 4 is a schematic diagram of partitions of a projection screen provided by embodiments of the present disclosure.

As shown in FIG. 4, the projection screen is usually placed on a wall or hung high in the use state. If the projection screen is rectangular, the bottom side of the projection screen is parallel to the horizontal direction, and the sides are parallel to the vertical direction, and the vertical direction is a direction perpendicular to the horizontal direction. When calculating the gain uniformity of the projection screen, the projection screen is evenly divided into three equal parts along the horizontal and vertical directions, so that the projection screen is divided into 9 areas S1 to S9. The gain uniformity is measured by the ratio between the average gain of areas S1, S3, S7, and S9 and the gain of area S5. When the gain of area S5 is set to the maximum, the limit of the gain uniformity of the projection screen is about 70%.

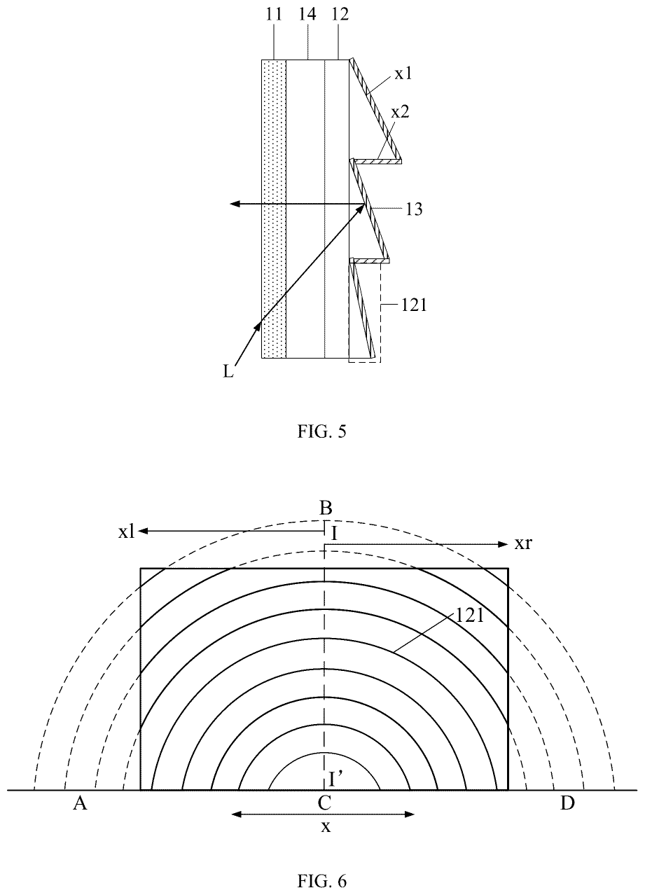

FIG. 5 is a first schematic diagram of a cross-sectional structure of a projection screen provided by embodiments of the present disclosure.

As shown in FIG. 5, the projection screen includes: a surface functional layer 11, a Fresnel lens layer 12 and a reflection layer 13.

The surface functional layer 11 can be located on the outermost surface of the projection screen. In the embodiments of the present disclosure, the surface functional layer 11 is located on the side closest to the audience, thereby protecting the projection screen. In addition, the surface functional layer 11 can also be processed in a variety of ways according to different needs to achieve the effects of expanding the viewing angle, resisting ambient light reflection, and resisting ceiling reflection.

FIG. 6 is a first schematic diagram of a planar structure of a Fresnel lens layer provided by embodiments of the present disclosure.

As shown in FIGS. 5 and 6, the Fresnel lens layer 12 is located on one side of the surface functional layer 11, specifically on the side of the surface functional layer 11 opposite to the audience. The Fresnel lens layer 12 includes a plurality of lens units 121 arranged according to a set rule.

According to different application scenarios and manufacturing processes, the lens unit 121 can adopt different structures. As shown in FIG. 6, multiple groups of lens units 121 are arranged in concentric arcs that expand in sequence along the radial direction. When the projection screen is applied to the ultra-short-throw projection system, the circle center O of the concentric lens unit 121 is usually not located in the projection screen, and the projection screen does not contain a complete lens unit, but contains a partial arc of the lens unit. When the projection device emits projection light from the bottom side of the projection screen to the projection screen, the circle center of the lens unit 121 can be located outside the projection screen and close to the bottom side, then the radius of each lens unit 121 gradually increases as it gradually moves away from the bottom side.

As shown in FIG. 5, the lens unit 121 includes a lens surface x1 and a non-lens surface x2 connected to each other. The lens surface x1 is tilted relative to the surface functional layer 11, and the inclination angle of the lens surface x1 is set according to the incident angle of the projection light, so as to reflect the outgoing light of the projection device toward the audience when it is incident on the reflection layer on its surface. The non-lens surface x2 is used to connect the lens surface x1.

The reflection layer 13 at least covers the lens surface of each lens unit 121 of the Fresnel lens layer 12. The lens surface of the lens unit has a specific inclination angle, so that the reflection layer 13 covering its surface also has a corresponding inclination angle, thereby allowing the projection light to be incident on the reflection layer 13 on the surface of the lens unit and reflected toward the location of the audience by the reflection layer 13.

In some embodiments, the reflection layer 13 can be a metal film formed by evaporation or sputtering process, and the metal film covers the surface of the lens unit 121, so that the surface of the metal film has the same undulation trend as the lens unit, and the surface of the metal film can maintain the reflection angle of the lens unit facing the incident light when designed. The metal film can be made of aluminum, silver, titanium and other metals, which are not limited here. When the structure shown in FIG. 5 is adopted and the reflection layer 13 is located on the back of the projection screen, aluminum paste or silver paste can also be applied.

As shown in FIG. 6, the projection screen is usually rectangular and includes four sides, and the adjacent sides are perpendicular to each other. When in use, the projection screen is usually set on a wall or hung at a high place, and the bottom side and the top side are usually parallel to the horizontal direction x, and the both sides are perpendicular to the horizontal direction. In the embodiments of the present disclosure, the projection screen is an axisymmetric figure, and its symmetry axis I-I′ is perpendicular to the bottom side, and each lens unit 121 is axially symmetrically distributed about the symmetry axis I-I′, and the circle center of each lens unit is located on the symmetry axis I-I′.

In the embodiments of the present disclosure, the inclination angle of the lens surface x1 of at least one lens unit 121 at a first location is greater than the inclination angle at a second location, where the distance from the first location to the symmetry axis I-I′ is greater than the distance from the second location to the symmetry axis I-I′, then the inclination angle of the lens surface of the lens unit 121 can satisfy: increasing as vertical distances from the lens surface x1 to the symmetry axis I-I′ increase. As shown in FIG. 6, each lens unit 121 can be divided into two parts, left and right, along the symmetry axis I-I′, where the inclination angle of the lens surface x1 of the lens unit on the left side gradually increases along the first direction xl, and the inclination angle of the lens surface x1 of the lens unit on the right side gradually increases along the second direction xr. The inclination angles of the lens surfaces of the same lens unit are mutually symmetrical about the symmetry axis I-I′, that is, in the same lens unit 121, the inclination angles of the lens surfaces at locations where the vertical distances from the left and right sides to the symmetry axis I-I′ are equal are equal, that is, in the same lens unit 121, the inclination angles of the lens surfaces at locations that are mutually symmetrical about the symmetry axis I-I′ are equal.

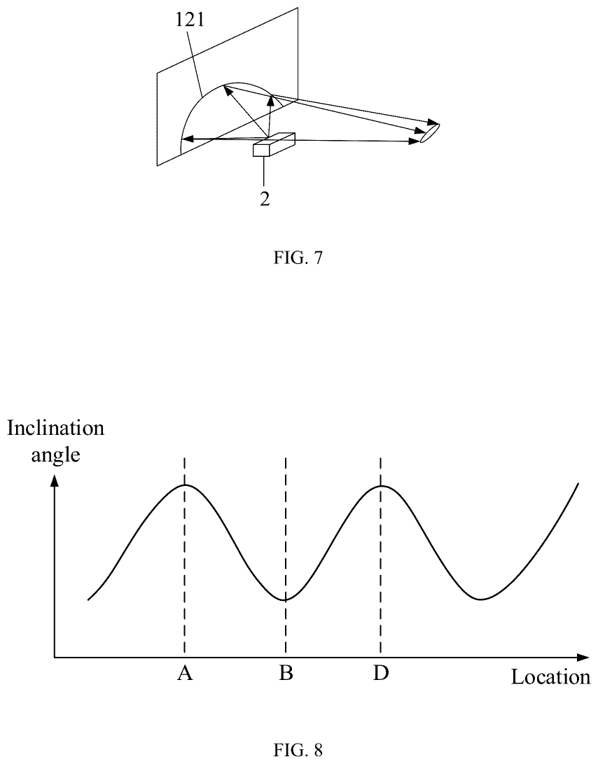

FIG. 7 is a second schematic diagram of a projection effect provided by embodiments of the present disclosure.

In the embodiments of the present disclosure, the inclination angle of the lens surface of at least one lens unit is set to increase as the vertical distance from the lens surface to the symmetry axis I-I′ increases, that is, the inclination angles of the lens surfaces at both sides of the same lens unit are larger, as shown in FIG. 7, so that the light incident on both sides can be concentrated more toward the middle location. By comparing FIG. 4 and FIG. 7, it can be seen that through the above-mentioned setting of the present disclosure, the light collection effect of the lens unit can be optimized, thereby improving the gain uniformity of the projection screen.

Based on the above principle, in order to concentrate more light at the edge of the projection screen to the central location and improve the gain uniformity of the projection screen, the embodiments of the present disclosure set all lens units in the projection screen so that the inclination angle of the lens surface increases with the increase of the vertical distance from the lens surface to the symmetry axis I-I′ of the projection screen, thereby concentrating the light to the middle location to the greatest extent.

As shown in FIG. 6, if the intersection locations of the lens unit 121 and the bottom side of the projection screen are A and D, the intersection point of the bottom side and the symmetry axis I-I′ is C, and the intersection point of the upper side of the projection screen and the symmetry axis I-I′ is B, then the inclination angle of the lens surface at each location of the lens unit satisfies the rule shown in FIG. 8. FIG. 8 is a first curve showing variation of an inclination angle of a lens surface of a lens unit at a different location provided by embodiments of the present disclosure. It can be seen from FIG. 8 that the change in the inclination angle of the lens surface of the same lens unit satisfies the sine function. From location A to location B and then to location D, the inclination angle of the lens surface of the lens unit first gradually decreases and then gradually increases, changing in a sinusoidal curve.

For a lens unit 121, the A/D location is the location of the lens unit close to the edges of both sides of the projection screen, and the B location is the middle location of the lens unit. In order for the lens unit to focus the light from both sides to the middle location, the inclination angle of the lens surface of the lens unit at the locations on both sides needs to be larger than the inclination angle at the middle location, so that after the light enters the lens unit, more light is reflected to the middle location, achieving the effect of focusing light to the middle.

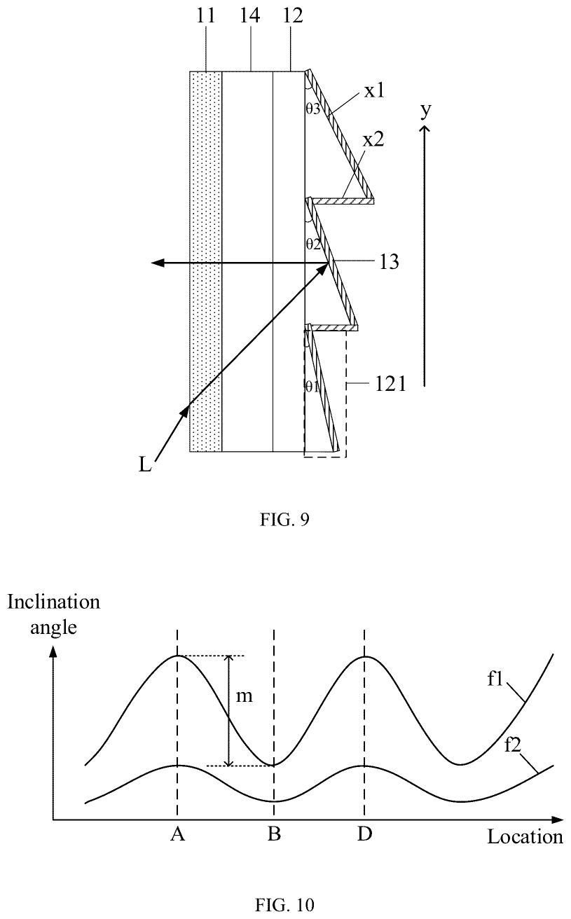

FIG. 9 is a schematic diagram of a cross-sectional structure of a projection screen along a symmetry axis I-I′ in FIG. 6.

As shown in FIG. 9, the projection device usually emits projection light L toward the projection screen at the middle location below the projection screen. Since the location of the projection device is fixed, the incident angle and direction of the projection light L when incident on different locations of the projection screen are different. In order to make the projection light be reflected toward the location where the audience is located, each lens unit needs to be designed into a concentric circle shape that expands sequentially along the radial direction, and the inclination angle of the lens surface x1 of each lens unit along the same radial direction is different. In the embodiments of the present disclosure, the inclination angle of the lens surface of each lens unit increases along the radial direction as the radius of the lens unit increases.

Taking FIG. 9 as an example, the inclination angle of the lens surface of the same lens unit varies at different locations (such as locations A, B, and D), so the inclination angles of the lens surfaces of the lens units along different directions are not comparable, but along the same direction, such as the radial direction y in FIG. 9, the radius of each lens unit increases successively, and the inclination angle of the lens surface x1 of each lens unit increases successively, that is, the inclination angle of the lens surface x1 of each lens unit along the radial direction y satisfies: 01<02<03. The location of the lens unit with a larger radius is closer to the edge of the projection screen. In order to allow the projection light incident on the lens unit to be reflected to the middle location, the inclination angle of the lens surface of the lens unit closer to the edge location needs to be set larger, so the inclination angle of the lens surface of the lens unit needs to be set to increase along the radial direction with the increase of the radius.

FIG. 10 is a second curve showing variation of an inclination angle of a lens surface of a lens unit at a different location provided by embodiments of the present disclosure.

As shown in FIG. 10, the variation law of the inclination angle of the lens surface of each lens unit satisfies the sine function. The larger the radius of the lens unit, the larger the range occupied by the plane where the projection screen is located. Therefore, the more drastic the change of the inclination angle of the lens surface of the lens unit from the edge location to the middle location, the greater the amplitude of the sine curve that it satisfies. Then according to the above law, the amplitude of the sine function satisfied by the inclination angle of the lens surface of each lens unit in the embodiments of the present disclosure increases with the increase of the radius of the lens unit. Taking FIG. 10 as an example, the sine curve f1 represents the variation law of the inclination angle of the lens surface of the lens unit with a larger radius, and the sine curve f2 represents the variation law of the inclination angle of the lens surface of the lens unit with a smaller radius. It can be seen from FIG. 10 that the amplitude of the sine curve f1 satisfied by the inclination angle of the lens surface of the lens unit with a larger radius is greater than the amplitude of the sine curve f2 satisfied by the inclination angle of the lens surface of the lens unit with a smaller radius.

In some embodiments, the projection screen can be used with an ultra-short-throw projection device, and the ultra-short-throw projection system can project a large-size image. According to the current projection screen size, the radius of the lens unit is within 2000 mm, and the change in the inclination angle of the lens surface of the same lens unit (m in FIG. 10) is greater than 0 and less than or equal to 2.25°. As the radius of the lens unit increases, the change in the inclination angle of its lens surface gradually increases. It has been experimentally verified that the change in the inclination angle of the lens surface of the lens unit increases with the increase in the size of the projection screen. When the radius of the lens unit is within 2000 mm, the maximum change in the inclination angle of the lens surface of the same Fresnel structure does not exceed 2.25°.

It is worth noting that the embodiments of the present disclosure only take the case where the radius of the lens unit in the projection screen is within 2000 mm as an example. When the size of the projection screen is further increased so that the radius of the lens unit exceeds 2000 mm, the change in the inclination angle of the lens surface of the lens unit may exceed 2.25°. The embodiments of the present disclosure do not limit the specific value of the change.

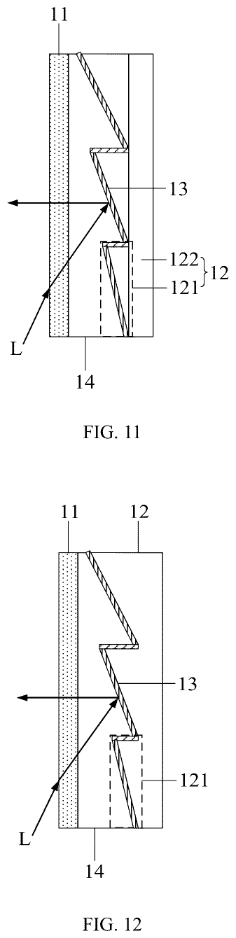

FIG. 11 is a second schematic diagram of a structure of a projection screen provided by embodiments of the present disclosure.

As shown in FIG. 5 and FIG. 11, the projection screen further includes: an binding layer 14, where the binding layer 14 is located between the surface functional layer 11 and the Fresnel lens layer 12 and is used to bond the surface functional layer 11 to the Fresnel lens layer 12. The binding layer 14 can be made of an acrylic or silicone adhesive, or a UV curable resin material, which is not limited here.

In some embodiments, as shown in FIG. 5, the lens unit 121 of the Fresnel lens layer 12 is located on the side away from the surface functional layer 11, and the binding layer 14 is used to bond the surface functional layer 11 to the surface of the Fresnel lens layer 12 opposite to the lens unit 121.

In some embodiments, as shown in FIG. 11, the lens unit 121 of the Fresnel lens layer 12 is located on the side facing the surface functional layer 11, and the binding layer 14 is used to bond the surface functional layer 11 to the reflection layer 13 on the surface of the lens unit 121. When the lens unit 121 is disposed on the side close to the binding layer 14, the binding layer 14 can protect the reflection layer 13. At this time, since the Fresnel lens layer 12 is located on the side farthest from the audience, and no light is incident on the Fresnel lens layer 12, the requirements on the light transmittance and damage of the Fresnel lens layer 12 are reduced, and it is no longer necessary to use expensive optical materials to make the Fresnel lens layer 12, and cheaper industrial materials can be used for production, thereby reducing production costs.

In some embodiments, as shown in FIG. 11, the Fresnel lens layer 12 includes a first substrate 122, the surface of the first substrate 122 facing the surface functional layer 11 and the surface on the opposite side of the surface functional layer 11 are both flat surfaces, and the lens unit 121 is located on the first substrate 122.

Here, the first substrate 122 can be made of materials such as polyethylene terephthalate (PET), polyethylene naphthalate (PEN), polycarbonate (PC), polymethyl methacrylate (PMMA), triacetylcellulose (TAC), cycloolefin polymer (COP), thermoplastic polyurethane (TPU), polyvinyl chloride (PVC), polyimide (PI), polyamide (PA), polyethylene (PE), and polypropylene (PP).

The lens unit 121 can be formed by applying UV (ultraviolet) curable resin to a mold having a lens unit shape, and UV curing the ultraviolet curable resin while imprinting it with the first substrate 122. In addition, the lens unit 121 can also be made of other materials combined with other manufacturing methods, which are not limited here.

FIG. 12 is a third schematic diagram of a structure of a projection screen provided by embodiments of the present disclosure.

In some embodiments, as shown in FIG. 12, the Fresnel lens layer 12 is an integrated structure, one side surface of the Fresnel lens layer 12 is a lens unit 121, and the other side surface is a flat surface. The Fresnel lens layer 12 with an integrated structure can omit the process of combining the substrate with the lens unit, further simplifying the manufacturing process. The Fresnel lens layer 12 with an integrated molding structure can be manufactured by thermoforming, which is not limited here.

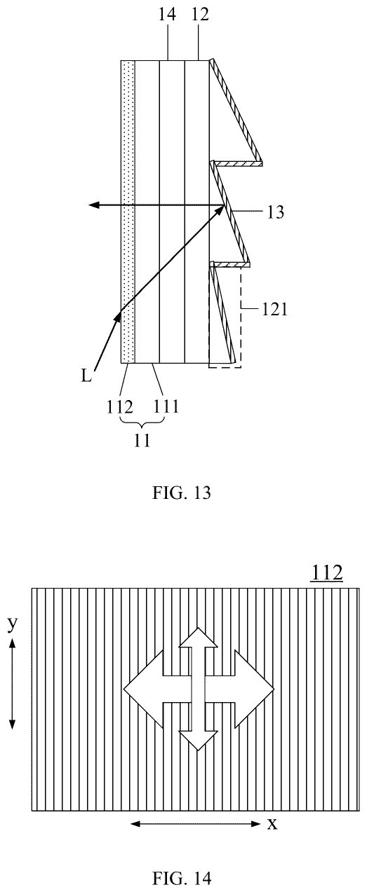

FIG. 13 is a fourth schematic diagram of a structure of a projection screen provided by embodiments of the present disclosure. FIG. 14 is a schematic diagram of a planar structure of a surface functional layer provided by embodiments of the present disclosure.

In some embodiments, the surface functional layer 11 has a light diffusion function, as shown in FIG. 13, the surface functional layer 11 can include: a second substrate 111 and a diffusion layer 112. The second substrate 111 serves as a substrate for the diffusion layer 112, the second substrate 111 is in contact with the binding layer 14, and the diffusion layer 112 is located on the surface of the second substrate 111 on the opposite side to the binding layer 14.

The current projection system usually uses a laser source. The laser has a high collimation, so the divergence angle of the projection light is small. The light reflected by the projection screen has a high collimation, which also leads to a small viewing angle. By setting the diffusion layer 112, the emission angle of the light after passing through the diffusion layer can be diversified, so that the light finally emitted by the projection screen has a certain divergence angle, which increases the viewing angle of the audience watching the projected image. In addition, the diffusion layer 112 is also conducive to suppressing the generation of laser speckle and optimizing the projection image.

The diffusion layer 112 can be formed on the surface of the second substrate 111 by making the resin material contain diffusion particles. The diffusion particles can be, but are not limited to, silicon dioxide particles, aluminum oxide particles, titanium oxide particles, cerium oxide particles, zirconium oxide particles, tantalum oxide particles, zinc oxide particles, magnesium fluoride particles, etc.

The second substrate 111 can be made of, but is not limited to, PET, PEN, PC, PMMA, TAC, COP, TPU, PVC, PI, PA, PE, PP and other materials.

In some embodiments, the diffusion layer 112 may have anisotropic diffusion properties, where anisotropic diffusion means that the diffusion angles in different directions are different. As shown in FIG. 14, the diffusion angle of the diffusion layer 112 along the horizontal direction x is greater than the diffusion angle along the vertical direction y. The horizontal direction x and the vertical direction y are different directions in the plane where the projection screen is located. The horizontal direction x is parallel to the bottom side of the projection screen; the vertical direction y is perpendicular to the horizontal direction and parallel to the symmetry axis I-I′ of the projection screen. The vertical direction y corresponds to the height direction when the audience watches the projection screen. If the diffusion angle of the diffusion layer in the vertical direction is larger, the light from the ceiling will also be diffused, resulting in an increase in the black field brightness of the projection screen. If the diffusion angle of the diffusion layer in the horizontal direction is large, the field of view angle of the projection screen in the left and right directions can be diffused. Therefore, by applying the anisotropy that the diffusion angle of the diffusion layer in the horizontal direction x is greater than the diffusion angle of the diffusion layer in the vertical direction y, the field of view angle of the projection screen in the horizontal direction can be increased while avoiding an increase in the black field brightness.

In a specific implementation, by manufacturing the diffusion layer into a structure in which the ridges are arranged along the vertical direction y, it is possible to achieve an effect that the diffusion angle in the horizontal direction x is greater than the diffusion angle in the vertical direction y.

As shown in FIG. 4, in the related art, when the inclination angle of the lens surface of the same lens unit is constant, the lens unit is a spherical mirror, which will produce astigmatism, so the areas S1, S4 and S7 of the projection screen, and the areas S3, S6 and S9 of the projection screen will emit light to both sides in the horizontal direction, so the gain uniformity of the projection screen deteriorates. When an anisotropic diffusion layer whose diffusion angle in the vertical direction y is smaller than the diffusion angle in the horizontal direction x is used, the gain uniformity of the projection screen will further decrease due to the increase in the diffusion degree in the horizontal direction. If the inclination angle of the lens surface of the lens unit is increased to suppress the diffusion of light in the horizontal direction, the light in the areas S2 and S5 of the projection screen will be emitted downward, thereby causing the front brightness of the projection screen to decrease. Therefore, in order to overcome the above problems, the diffusion angle of the diffusion layer in the vertical direction y is increased, so that the light can be further diffused from the bottom to the top, thereby improving the gain uniformity of the projection screen. As mentioned above, the increase in the diffusion angle of the diffusion layer in the vertical direction y will cause the black field brightness to increase, which will still affect the display effect.

In the embodiments of the present disclosure, the inclination angle of the lens surface of the lens unit is set so that the inclination angle at the edge location is greater than the inclination angle at the middle location, so that the light can be concentrated more at the middle location, and at the same time, an anisotropic diffusion layer is used in which the diffusion angle in the horizontal direction x is greater than the diffusion angle in the vertical direction y, so that the black field brightness can be reduced while suppressing the brightness reduction of the projection screen in areas S2 and S5.

The embodiments of the present disclosure also test the gain uniformity of the projection screen made according to the above concept. The specific production process is: an 80-inch lens unit is made on the surface of a 250 μm thick PET substrate to form a Fresnel lens layer; then, a reflection layer is formed on the surface of the lens unit by evaporating aluminum; next, a diffusion layer with a diffusion angle in the vertical direction smaller than the diffusion angle in the horizontal direction is made on the surface of a 250 μm thick PET substrate. The above two PET substrates are bonded to each other by a transparent adhesive to obtain a projection screen.

As shown in FIG. 4, the same method is used to measure the gain uniformity of the projection screen by the ratio between the average gain of areas S1, S3, S7, and S9 and the gain of area S5. By setting the inclination angle of the lens surface of the lens unit in the projection screen so that the inclination angle at the two side locations is greater than the inclination angle at the middle location, the gain uniformity of the projection screen can be improved to more than 80%, and the gain uniformity of the projection screen can be achieved to 100% by designing a reasonable inclination angle.

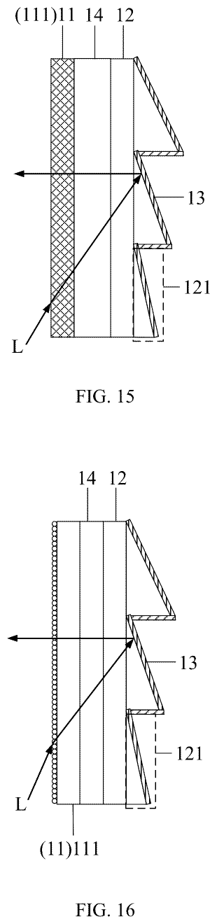

FIG. 15 is a fifth schematic diagram of a cross-sectional structure of a projection screen provided by embodiments of the present disclosure.

In some embodiments, as shown in FIG. 15, the surface functional layer 11 only includes a second substrate 111, where the second substrate 111 is in contact with the binding layer 14 and is bonded to the Fresnel lens layer 12 through the binding layer 14. The material of the second substrate 111 includes a diffusion material, so when the second substrate 111 is formed, the second substrate 111 can have a light diffusion ability and a certain haze. The second substrate 111 including the diffusion material can expand the field of view angle, and can also reduce the reflection of light, thereby preventing the light from forming a clear image on the ceiling, having the effect of anti-ceiling reflection, and can enhance the viewing experience of the audience.

FIG. 16 is a sixth schematic diagram of a cross-sectional structure of a projection screen provided by embodiments of the present disclosure.

In some embodiments, as shown in FIG. 16, the surface functional layer 11 includes only a second substrate 111, where the second substrate 111 is in contact with the binding layer 14 and is bonded to the Fresnel lens layer 12 through the binding layer 14. The surface of the second substrate 111 on the opposite side of the binding layer 14 is an uneven surface. The uneven surface can be formed by sandblasting or alkali treating the surface of the second substrate 111, which is not limited here. The uneven surface of the second substrate 111 can play a certain role in light diffusion and atomization, thereby expanding the viewing angle, resisting ceiling reflection, and the like.

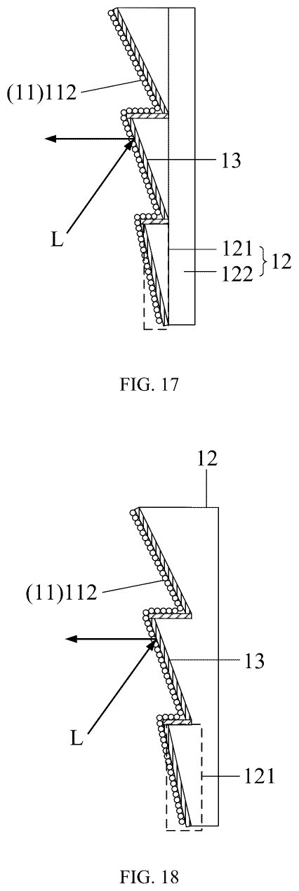

FIG. 17 is a seventh schematic diagram of a cross-sectional structure of a projection screen provided by embodiments of the present disclosure. FIG. 18 is an eighth schematic diagram of a cross-sectional structure of a projection screen provided by embodiments of the present disclosure.

In some embodiments, as shown in FIGS. 17 and 18, the projection screen can also include only the Fresnel lens layer 12, the reflection layer 13 and the surface functional layer 11. The lens unit 121 of the Fresnel lens layer 12 is arranged on the side facing the viewer, the reflection layer 13 is located on the surface of the lens unit 121, and the surface functional layer 11 is located on the surface of the reflection layer 13. At this time, the surface functional layer adopts a diffusion layer 112 covering the reflection layer 13. The diffusion layer 112 can be formed on the surface of the reflection layer 13 by coating, splighting, etc. The projection screen structure shown in FIGS. 17 and 18 can effectively reduce the thickness of the projection screen. The Fresnel lens layer 12 can adopt the structure shown in FIG. 17, including a first substrate 122 and a lens unit 122 located on the first substrate 122, or can adopt the integrated structure shown in FIG. 18.

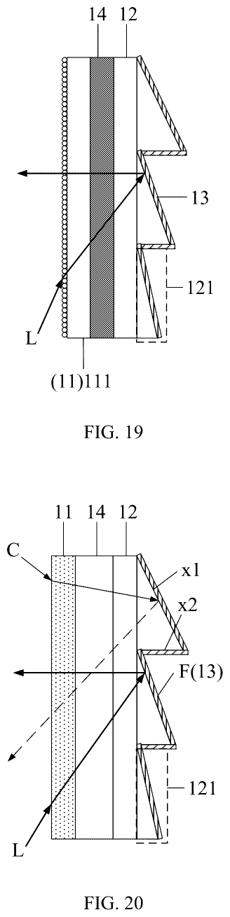

FIG. 19 is a ninth schematic diagram of a cross-sectional structure of a projection screen provided by embodiments of the present disclosure.

In some embodiments, as shown in FIG. 19, the binding layer 14 may contain a light absorbing material and color the binding layer 14 to improve the black brightness of the projection screen. In some embodiments, the binding layer 14 can be colored with a dark material such as carbon black or dye to deepen the color of the binding layer 14, which is not limited here.

As shown in FIG. 2, the projection light L emitted by the projection device is incident on the inside of the projection screen, and is reflected by the reflection layer 13 after being incident on the reflection layer 13, and then is emitted from the projection screen in the direction of the audience. At the same time, the ambient light C can also be incident on the inside of the projection screen. Similarly, some ambient light will also be reflected when incident on the reflection layer 13 and will be emitted from the projection screen. These reflected ambient lights will interfere with the projection light, thereby reducing the contrast of the projected image.

In order to overcome the above problems, in the related art, the film layer in the projection screen is usually colored, so that the colored film layer can absorb the incident ambient light and reduce the reflection of the ambient light.

As shown in FIG. 19, the binding layer 14 can be colored, and dyes, carbon black and other light-absorbing substances can be mixed into the material of the binding layer 14, so that the ambient light is absorbed when it enters the binding layer 14. However, since the colored film layer in the projection screen absorbs light of all wavelengths, the projection light L has a reduced emission efficiency after entering the colored film layer (such as the binding layer 14), and cannot improve the contrast.

In order to improve the contrast of the projected image, as shown in FIG. 20, in some embodiments, the reflection layer may adopt a wavelength selection based reflection layer F, which can selectively reflect the projection light emitted by the projection device, while greatly reducing the reflectivity of a light in other bands. When the projection device is turned off, a black appearance can be achieved, and when the projection device is turned on, a bright display can be obtained, thereby significantly improving the contrast of the projected image.

As shown in FIG. 20, the projection light L emitted by the projection device is incident in the inside of the projection screen from the side of the surface functional layer 11, and is reflected by the wavelength selection based reflection layer F on the surface of the lens unit 121 when incident on the lens unit 121, thereby reflecting in the direction of the audience. At the same time, the ambient light C is incident in the inside of the projection screen from the side of the surface functional layer 11. When the ambient light C is incident on the wavelength selection based reflection layer F on the surface of the lens unit, since the wavelength selection based reflection layer F only reflects the projection light, the reflectivity of the ambient light in other wavelength bands is low, so the reflection of the ambient light can be greatly reduced, and the contrast of the projection light can be improved.

Specifically, the wavelength selection based reflection layer F uses the principle of the resonance cavity to select the wavelength of the light emitted toward the audience, while other wavelengths are restricted in the resonance cavity and cannot be emitted, thereby achieving the effect of selective reflection of the projection light.

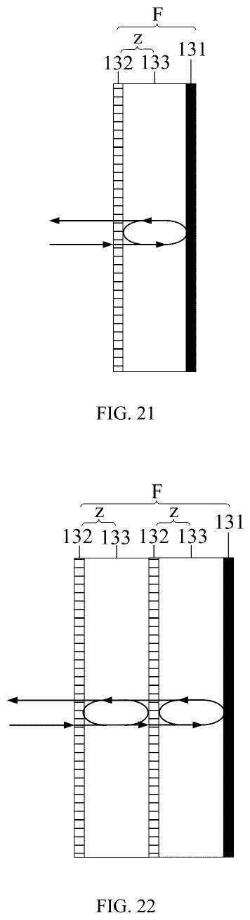

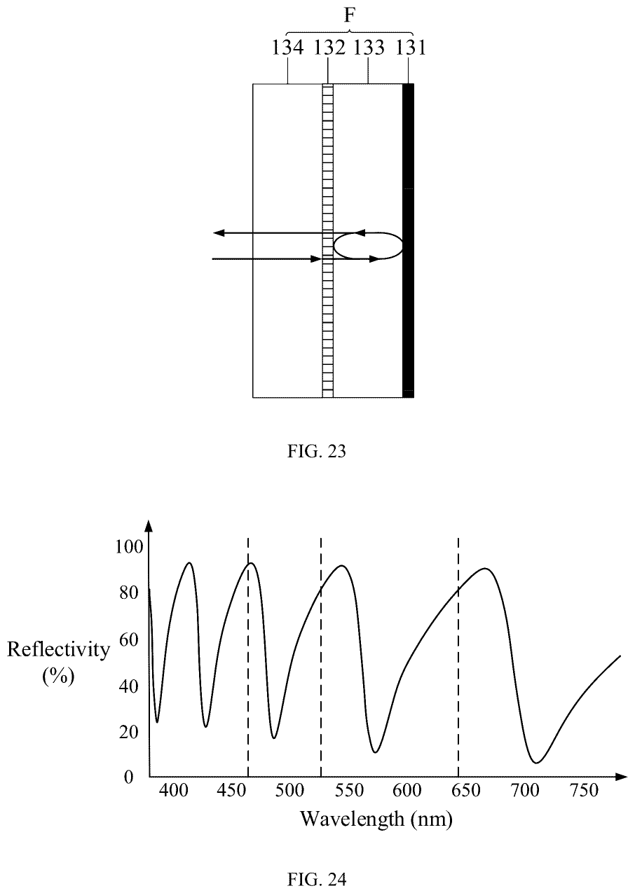

FIG. 21 is a first schematic diagram of a structure of a wavelength selection based reflection layer provided by embodiments of the present disclosure. FIG. 22 is a second schematic diagram of a structure of a wavelength selection based reflection layer provided by embodiments of the present disclosure. FIG. 23 is a third schematic diagram of a structure of a wavelength selection based reflection layer provided by embodiments of the present disclosure.

As shown in FIG. 21 and FIG. 22, the wavelength selection based reflection layer F includes: a light reflective layer 131 and at least one film layer group z located on the light reflective layer 131. The film layer groups z are stacked and each film layer group z includes: a translucent layer 132 and a light-transmitting medium layer 133.

The light reflective layer 131 has the function of reflecting light. The light reflective layer 131 is located on the side away from the audience and does not need to transmit light. Therefore, the light reflective layer 131 can be made of a material with reflective properties but no light-transmitting properties. In some embodiments, the light reflective layer 131 can be made of materials such as aluminum, aluminum alloy, silver or silver alloy. For example, the light reflective layer 131 can be made of aluminum alloys such as Al and AlSi, or a laminated structure composed of silver alloys such as Ag and AgPaCu, which is not limited here. The light reflective layer 131 can be made by sputtering, evaporation and other methods, which is not limited here.

For each film layer group z, the translucent layer 132 is located on the side close to the surface functional layer 11, the light reflective layer 131 is located on the side of the translucent layer 131 opposite to the surface functional layer 11, and there is a certain distance between the translucent layer 132 and the light reflective layer 131. The light-transmitting medium layer 133 is located between the translucent layer 132 and the light reflective layer 131. The light reflective layer 131, the translucent layer 132 and the light-transmitting medium layer 133 form a resonant cavity structure.

In some embodiments, the wavelength selection based reflection layer F can be set to a single resonance structure as shown in FIG. 21, that is, the light reflective layer 131, the translucent layer 132 and the light-transmitting medium layer 133 form a resonance structure; or the wavelength selection based reflection layer F can be set to a double resonance structure as shown in FIG. 22, that is, the light reflective layer 131, the translucent layer 132 and the light-transmitting medium layer 133 form a resonance structure, and the adjacent translucent layer 132, the light-transmitting medium layer 133 and the translucent layer 132 form another resonance structure; and so on, the wavelength selection based reflection layer F can also include more than two resonance structures. The more resonance structures included in the wavelength selection based reflection layer F, the more precise its wavelength selectivity, and the cost will also increase accordingly. Therefore, it is necessary to strike a balance between performance and cost.

Specifically, the translucent layer 132 in the wavelength selection based reflection layer F has a semi-transparent and semi-reflective property, so that when the projection light is incident on the projection screen, the projection light can be incident on the resonance structure, and when the projection light oscillates and strengthens in the resonance structure, it can also be emitted from one side of the translucent layer 132. In some embodiments, the translucent layer 132 can be a laminated structure formed by at least one metal selected from Al, Nb, Ag and Ti, etc., which is not limited here. The translucent layer 132 can be manufactured by sputtering, evaporation and other methods, which are not limited here.

The thickness of the light-transmitting medium layer 133 determines the cavity length of the resonance structure, and the product of the refractive index and thickness of the light-transmitting medium layer 133 determines the wavelength of the light emitted from the resonance structure to the audience and the wavelength of the light extinguished inside the resonance structure. Therefore, when designing the resonance structure, it is necessary to select a dielectric material whose refractive index and thickness product satisfies the conditions for the projection light emitted by the projection device to resonate. In some embodiments, the light-transmitting medium layer 133 can be made of materials such as metal oxides, nitrides or transparent resins. For example, the light-transmitting medium layer 133 can be made of metal oxides or nitrides such as TiO2, Nb2O5, ZrO2, Al2O3, ZnO2, SiO2, etc., and can be made by reactive sputtering, electron beam (EB) evaporation, chemical vapor delocation, etc.; or it can also be made of a laminated structure of one or more of transparent resins such as PMMA, PC, PS, etc., and made by wet processing processes such as gravure printing and die coating, which are not limited here.

In some embodiments, as shown in FIG. 23, the wavelength selection based reflection layer F may further include a substrate 134, and the substrate 134 is located on the side of the translucent layer 132 opposite to the light-transmitting medium layer 133. The substrate 134 serves as the base of the resonance cavity and has a supporting and bearing function. In a specific implementation, the substrate 134 can be made of materials such as PET, which is not limited here.

In the embodiments of the present disclosure, the projection light source can adopt a three-color laser source device, which can emit red laser light, green laser light and blue laser light. Then, by adjusting the refractive index and thickness of the material of the light-transmitting medium layer, the resonance cavity can simultaneously enhance the reflection of red laser light, green laser light and blue laser light, while attenuating the reflection of light in other bands, thereby improving the contrast of the projection light.

FIG. 24 is a reflectivity curve of a wavelength selection based reflection layer to light of different wavelength bands provided by embodiments of the present disclosure. The location of the dotted line in FIG. 24 is the location of the peak wavelength of the three-color laser emitted by the three-color laser source device. As can be seen from FIG. 24, the wavelength selection based reflection layer can have a high reflectivity at the wavelengths of the red laser light, green laser light and blue laser light emitted by the projection device at the same time, while the reflectivity at other wavelength bands is significantly reduced, which is conducive to improving the contrast of the projection light.

According to simulation tests, when the thickness of the translucent layer 132 is in the range of 2 nm to 20 nm, the thickness of the light reflective layer 131 is greater than 50 nm and less than 100 nm, and the product of the thickness and the refractive index of the light-transmitting medium layer 133 is in the range of 1200 to 1800, the effect is better.

It is worth noting that the thickness of the light reflective layer 131, the translucent layer 132 and the light-transmitting medium layer 133 in the wavelength selection based reflection layer F mainly focuses on the thickness of the film layer located on the lens surface x1 of the lens unit 121, and the thickness refers to the thickness of the film layer along the lens surface x1 perpendicular to the lens unit 121. This is because when designing the wavelength selection based reflection layer F, the materials of each film layer in the wavelength selection based reflection layer and the cavity length of the resonance cavity are selected and designed based on the incident angle range of the incident light on the lens surface x1 being ±15°. The thickness and refractive index of the light-transmitting medium layer 133 in the wavelength selection based reflection layer F along the direction perpendicular to the lens surface x1 are related to the wavelength of selective reflection, so the coating thickness of the light-transmitting medium layer 133 needs to be accurately controlled.

Taking the example that the light reflective layer 131, the translucent layer 132 and the light-transmitting medium layer 133 in the wavelength selection based reflection layer F are all manufactured by the coating process, the structure of each film layer in the embodiments of the present disclosure is specifically described.

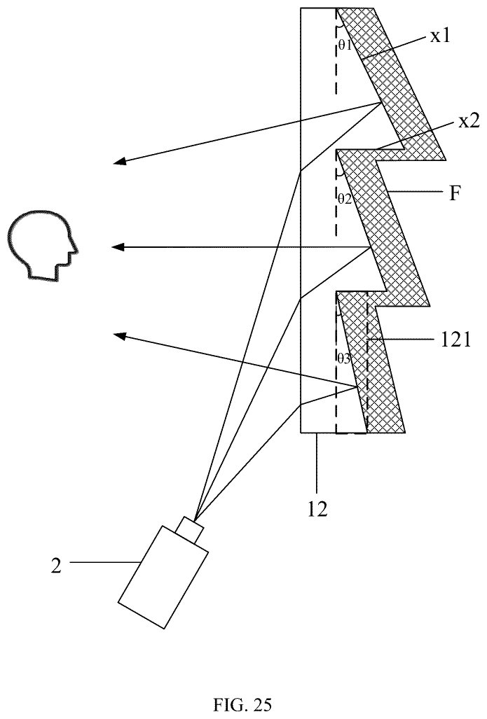

FIG. 25 is a schematic diagram of an optical path of projection light incident on a projection screen provided by embodiments of the present disclosure.

As shown in FIG. 25, when the projection device is located below the bottom of the projection screen, the incident angles of the projection light emitted by the projection device when incident on different locations of the projection screen are also different. In order to make more projection light focus on the location where it is located, as shown in FIG. 25, the inclination angles of the lens surface x1 of each lens unit 121 are different. Taking the Fresnel lens layer 12 shown in FIG. 25 as an example, along the direction gradually away from the projection device 2 (away from the bottom side of the projection screen), the radius of each lens unit 121 increases successively, and the inclination angle of the lens surface x1 of each lens unit 121 gradually increases, that is, 03<02<01. After reasonable design, when the angle of the projection light incident on the projection screen is 65° to 85°, the incident angle range of the projection light incident on the lens surface x1 of different lens units is within the range of 10° to 15°.

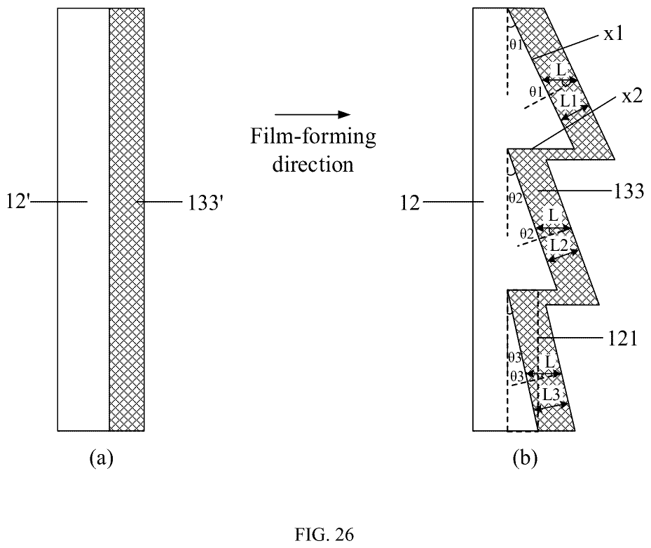

FIG. 26 is a first schematic diagram of coating provided by embodiments of the present disclosure.

In the related art, as shown in (a) in FIG. 26, the coating process is usually a process of depositing a thin film on a flat surface 12′, and the film forming direction is perpendicular to the flat surface 12′ as shown in the direction of the arrow in FIG. 26, that is, the thickness of the thin film 133′ at each location on the flat surface 12′ perpendicular to the flat surface 12′ is basically the same.

However, as shown in (b) of FIG. 26, in the embodiments of the present disclosure, it is necessary to coat the surface of the lens units 121 in a concentric circle shape. Then, when the light-transmitting medium layer 133 is formed by the same coating process, the obtained film layer is still uniform in thickness in the film-forming direction, that is, the thickness L of the light-transmitting medium layer 133 on each lens unit 121 along the plane perpendicular to the projection screen (parallel to the film-forming direction in FIG. 26) is equal. However, the inclination angles of the lens surfaces x1 of each lens unit 121 are different, so the thicknesses of the light-transmitting medium layers 133 on the surfaces of different lens units along the thickness perpendicular to the lens surface x1 are not equal.

For the sake of convenience, the thickness of the film layer parallel to the film forming direction is referred to as the plane thickness, and the thickness of the film layer perpendicular to the lens surface of the lens unit is referred to as the vertical thickness. According to the relationship shown in FIG. 26, the vertical thickness of the light-transmitting medium layer 133 is L×cos θ, where θ is the inclination angle of the lens surface x1 of the lens unit 121. Taking FIG. 26 as an example, the vertical thickness of the light-transmitting medium layer 133 on different lens units 121 from the bottom to the top of the projection screen satisfies: L3=L×cos θ3, L2=L×cos θ2, L1=L×cos θ 1; and the inclination angle of the lens surface x1 of each lens unit increases with the increase of the radius of the lens unit, that is, θ1>θ2>θ3, then according to the above relationship, it can be known that: L1<L2<L3.

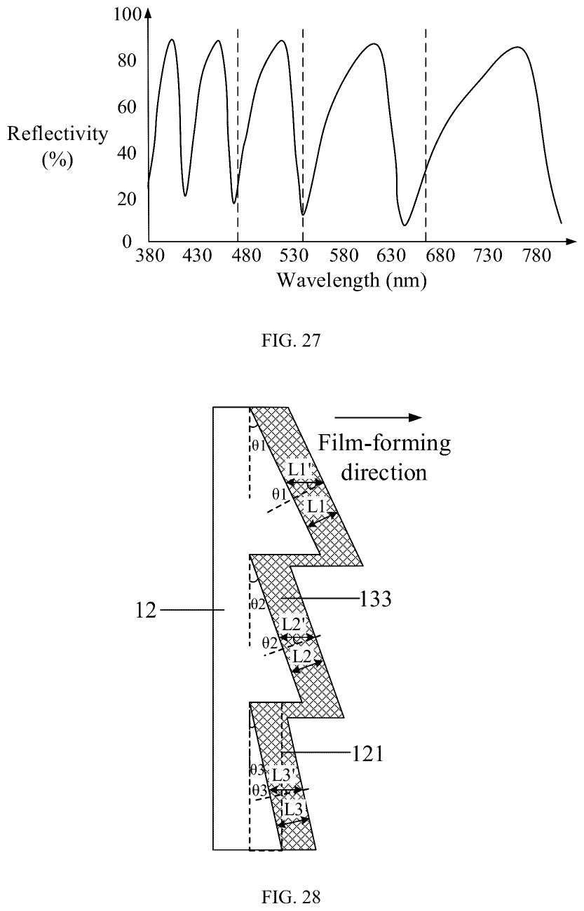

FIG. 27 is a reflectivity curve of a wavelength selection based reflection layer produced by a wavelength shift provided by embodiments of the present disclosure.

Comparing FIG. 24 and FIG. 27, when the light-transmitting medium layer 133 is made of Nb₂O₅, when the thickness of the light-transmitting medium layer 133 increases by 10%, the wavelength selection basedly reflected by the wavelength selection based reflection layer will shift toward the long-wave direction.

It can be seen that when the wavelength selection based reflection layer F is manufactured by the existing coating process, the thickness of the light-transmitting medium layer along the lens surface perpendicular to the lens unit decreases as the radius of the lens unit increases. This will cause the color near the bottom of the screen to be reddish when the projection screen displays a full white image, and the color uniformity of the screen is reduced.

In view of this, when manufacturing the wavelength selection based reflection layer F in the projection screen, the coating device is adjusted in the embodiments of the present disclosure so that the wavelength selection based reflection layer F covering the lens surface x1 of each lens unit 121, especially the thickness of the light-transmitting medium layer 133 in the wavelength selection based reflection layer F along the direction perpendicular to the lens surface x1, can be equal, thereby improving the chromaticity uniformity of the projection screen.

FIG. 28 is a second schematic diagram of coating provided by embodiments of the present disclosure.

When manufacturing the wavelength selection based reflection layer F, especially the light-transmitting medium layer 133, the thickness of the film layer can be controlled in the film forming direction, so that the thickness of the film layer in the wavelength selection based reflection layer F along the plane perpendicular to the projection screen increases with the increase of the radius of the lens unit, thereby ensuring that the thickness of the film layer along the plane perpendicular to the lens surface x1 on each lens unit 121 is equal or approximately equal. Taking FIG. 28 as an example, the thickness of the light-transmitting medium layer 133 along the plane perpendicular to the lens surface x1 on different lens units 121 from the bottom to the top of the projection screen (i.e., the above-mentioned vertical thickness) satisfies: L3=L2=L1, and the thickness of the light-transmitting medium layer 133 along the plane perpendicular to the projection screen (i.e., the above-mentioned plane thickness) satisfies: L3′<L2′<L1′.

It should be noted that when the reflection layer adopts the wavelength selection based reflection layer F, the manufacturing order of each film layer in the wavelength selection based reflection layer F is different according to the setting direction of the Fresnel lens layer 12. In some embodiments, as shown in FIG. 20, when the lens unit 121 of the Fresnel lens layer 12 is located on the side away from the binding layer 14, it is necessary to form a translucent layer, a light-transmitting medium layer and a reflection layer on the lens unit 121 in sequence. In some embodiments, as shown in FIG. 11, when the lens unit 121 of the Fresnel lens layer 12 is arranged facing the binding layer 14, it is necessary to form a reflection layer, a light-transmitting medium layer and a translucent layer on the lens unit 121 in sequence, which is opposite to the above manufacturing order.

As shown in FIG. 20, the projection light L emitted by the projection device is incident in the inside of the projection screen from the side of the surface functional layer 11, and is reflected by the reflection layer 13 on the surface of the lens unit when incident on the lens unit 121, thereby reflecting in the direction where the audience is located. Generally, the projection screen including the reflection layer 13 is a reflective screen, and the film layers before the light is incident on the reflection layer 13 are all light-transmissive.

In some embodiments, at least one of the light-transmitting film layers of the projection screen can contain a low-valent oxide, thereby reducing the transmittance of the light-transmitting film layer to the visible light band, that is, the low-valent oxide has a certain absorptivity to the visible light band. Therefore, when displaying a black image, it can absorb the incident ambient light and improve the black brightness of the projection screen.

The low-valent oxide is an incomplete oxide. In some embodiments, a metal low-valent oxide can be used, and the transmittance to the visible light band can be changed by controlling the oxygen content of the metal low-valent oxide. The metal low-valent oxide is transition products of metals during the oxidation process. Metals are mostly opaque substances. From the metallic state to the oxide state after complete oxidation, the transmittance to the visible light band will gradually increase, and the absorptivity will gradually decrease. Finally, it will be completely oxidized into an oxide that is transparent to the visible light band. In the embodiments of the present disclosure, the oxide formed by the completely oxidized metal is called the metal complete oxide, and the oxide formed by the incompletely oxidized metal is called the metal low-valent oxide.

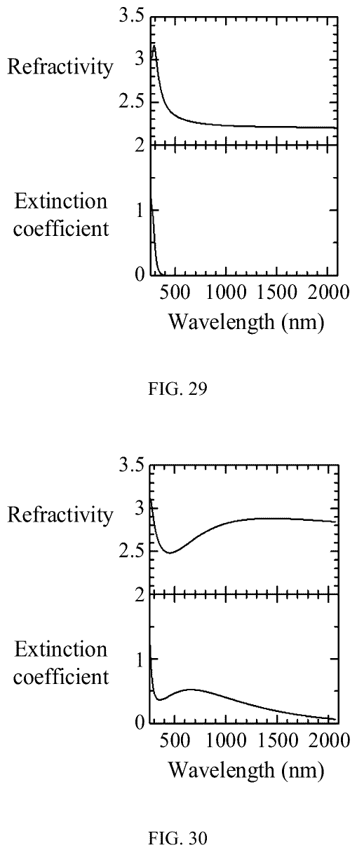

The following is a detailed introduction to the changes in optical parameters during metal oxidation. FIG. 29 is a curve showing changes in optical parameters of a metal complete oxide provided by embodiments of the present disclosure. FIG. 30 is a curve showing changes in optical parameters of a metal low-valent oxide provided by embodiments of the present disclosure.

Generally, optical parameters include parameters that characterize various aspects of performance. The main parameters that need to be considered in the projection screen are a refractive index n and an extinction coefficient k. Here, the extinction coefficient k determines the absorption capacity of the incident visible light band. The larger the extinction coefficient is, the stronger the absorption capacity is. Comparing FIGS. 29 and 30, it can be seen that the refractive index n of the metal complete oxide decreases with the increase of wavelength and then tends to be constant, and the extinction coefficient k decreases rapidly with the increase of wavelength, and the value of the visible light band is 0, that is, it has no light absorption in the visible light band. For the metal low-valent oxide, the refractive index n will tend to decrease first and then increase with the increase of wavelength, and the extinction coefficient k will tend to decrease first, then increase and then decrease with the increase of wavelength, and the value of the extinction coefficient k in the visible light band is above 0, so it has an absorption effect on the visible light band. Therefore, by adding a metal low-valent oxide to any one of the light-transmitting film layers in the projection screen, the film layer can have certain light absorption properties in the visible light band while being light-transmitting.

In specific implementations, the metal low-valent oxide can be produced by a reactive sputtering process with plasma luminescence control. In the sputtering chamber, the sputtering source is metal. In addition to using discharge gases such as argon, reactive gases such as oxygen are also needed. The plasma luminescence intensity is adjusted by controlling the flow rate of the reactive gas to form the metal low-valent oxide. There is a transition state in the process from the metallic state to the fully oxidized metal oxide, and the metal low-valent oxide can be formed in the transition region.

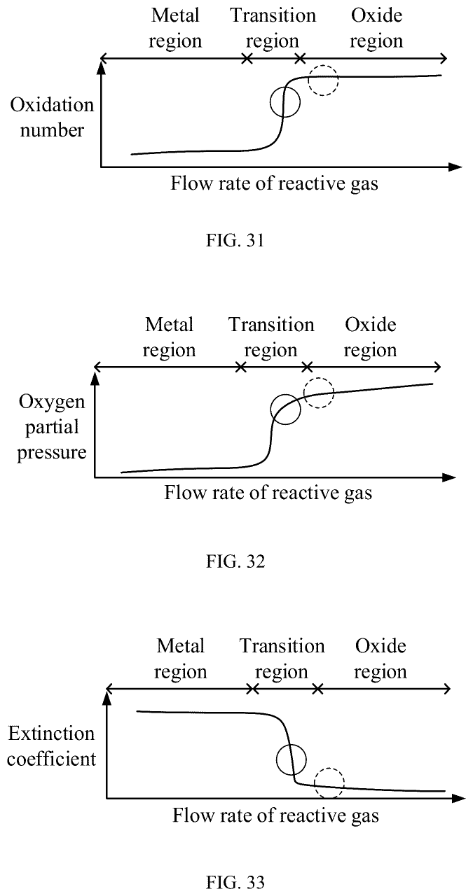

Specifically, FIG. 31 is a curve showing the change of oxidation number with the flow rate of reactive gas in the reactive sputtering process of plasma luminescence control provided by embodiments of the present disclosure. FIG. 32 is a curve showing the change of oxygen partial pressure with the flow rate of reactive gas in the reactive sputtering process of plasma luminescence control provided by embodiments of the present disclosure. FIG. 33 is a curve showing the variation of the extinction coefficient with the reactive gas flow rate in the reactive sputtering process of plasma luminescence control provided by embodiments of the present disclosure. Here, the sputtering source is metal, the reactive gas is oxygen, and the metal will be gradually oxidized during the sputtering process, and gradually converted from the metal state to the metal complete oxide state. The solid circle frame in FIG. 31 to FIG. 33 is the metal low-valent oxide state, and the dotted circle frame is the metal complete oxide state.

As shown in FIGS. 31 and 32, as the flow rate of the reactive gas gradually increases, the main component of the substance formed in the metal region is metal, and the oxidation number and oxygen partial pressure tend to increase slowly; when it reaches the transition region, the metal is partially oxidized, and the main component is the metal low-valent oxide, and the oxidation number and oxygen partial pressure increase significantly; and when it reaches the oxide region, the metal is completely oxidized into the metal complete oxide, and the oxidation number and oxygen partial pressure show a trend of slowly increasing, and after the flow rate of the reactive gas increases to a certain extent, the oxidation number and oxygen partial pressure tend to stabilize.

As shown in FIG. 33, as the flow rate of the reactive gas gradually increases, the main component of the substance formed in the metal region is still metal, so the extinction coefficient is large, the light absorption is strong and the light transmittance is poor; as the flow rate of the reactive gas gradually increases, the metal is gradually oxidized, and when the metal is oxidized into a metal low-valent oxide in the transition region, its extinction coefficient greatly decreases, but it still has a certain light absorption and the light transmittance increases; as the flow rate of the reactive gas increases to a certain extent, the metal is completely oxidized to form a metal complete oxide, at which time the extinction coefficient is reduced to the minimum value and it no longer has light absorption.

It can be seen that by controlling the oxygen content of the metal low-valent oxide, its extinction coefficient can be changed, so that the metal low-valent oxide has different degrees of absorption of visible light.

In order to improve the contrast of the projected image, the reflection layer 13 can adopt a wavelength selection based reflection layer F. Based on the above analysis, a low-valent oxide can be used in the wavelength selection based reflection layer F to make it have both wavelength selection based reflectivity and absorption of incident light, thereby improving the performance of the projection screen.

As described above, the product of the refractive index and thickness of the light-transmitting medium layer 133 in the wavelength selection based reflection layer F determines the wavelength selected for reflection by the wavelength selection based reflection layer. In some embodiments, the light-transmitting medium layer 133 can be made of metal complete oxides such as TiO2, Nb2O5, ZrO2, Al2O3, ZnO2, SiO2, etc. However, these metal complete oxides are transparent to light in the visible light band. In order to make the wavelength selection based reflection layer F have both wavelength-selective reflectivity and absorptivity, the light-transmitting medium layer 133 can contain low-valent oxides. As described above, the light-transmitting medium layer 133 can be made of metal low-valent oxides, or metal low-valent oxides can be added to the material of the light-transmitting medium layer 133, and the transparency of the metal low-valent oxides can be reduced to a certain extent by controlling the oxygen content of the metal low-valent oxides.

In this way, the wavelength selection based reflection layer F can have both wavelength selection based reflection and certain light absorption in the visible light band, which can shield the ambient light. There is no need to set a separate light absorption layer in the projection screen, which simplifies the structure of the projection screen and reduces the production cost.

In some embodiments, the material of the light-transmitting medium layer 133 in the wavelength selection based reflection layer F can all be low-valent oxides.

In some embodiments, the material of the light-transmitting medium layer 133 in the wavelength selection based reflection layer F can include low-valent oxides and complete oxides. For example, the low-valent oxides and complete oxides can be layered.

In some embodiments, the light-transmitting medium layer 133 can include a first medium layer and a second medium layer arranged in a stacked manner; where the first medium layer can be made of a low-valent oxide, and the second medium layer can be made of a complete oxide; or, the first medium layer can be made of a complete oxide, and the second medium layer can be made of a low-valent oxide. The setting order of the low-valent oxide and the complete oxide is not limited.

Each film layer in the wavelength selection based reflection layer F can be manufactured by a sputtering process. When the light-transmitting medium layer 133 is formed by sputtering, the metal is oxidized to different degrees by controlling the flow rate of the reactive gas, i.e., oxygen. When the metal is partially oxidized, a metal low-valent oxide is formed, and when the metal is completely oxidized, a metal complete oxide is formed. The absorption capacity of the film layer formed by reactive sputtering to the incident light decreases with the increase of the oxygen content. Therefore, in order to enable the light-transmitting medium layer 133 to achieve a suitable light absorption effect, the flow rate of the reactive gas needs to be finely controlled.

In specific implementations, the metal low-valent oxide in the light-transmitting medium layer can be one of Nb2O5-x, TiO2-y or Ta2O5-z, where 0<x<5, 0<y<2, 0<z<5, and x, y, and z can be integers or decimals within the above ranges, which are not limited here. In addition to the above materials, other metal low-valent oxides can also be used, which are not listed here one by one.

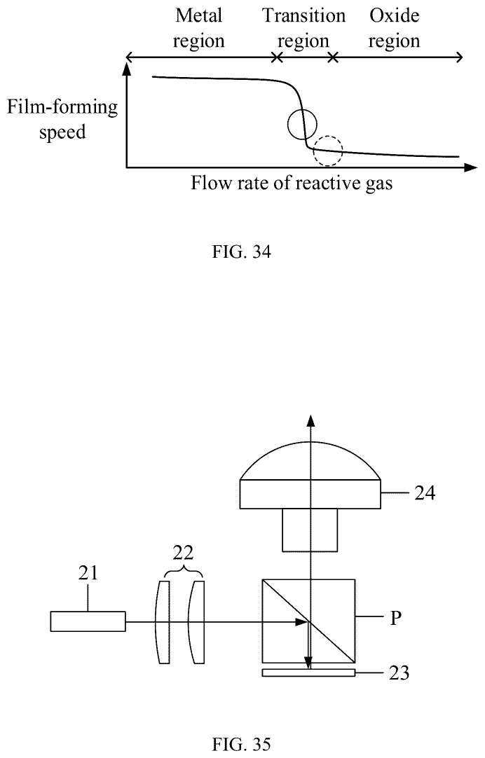

FIG. 34 is a curve showing the change of film forming speed with the change of reactive gas flow rate in the reactive sputtering process controlled by plasma luminescence provided by embodiments of the present disclosure.

As shown in FIG. 34, as the flow rate of the reactive gas gradually increases, the main component of the film layer in the metal region is still metal, so the film formation speed is faster; as the flow rate of the reactive gas gradually increases, the metal is gradually oxidized, and the film formation speed decreases accordingly; as the flow rate of the reactive gas increases to a certain extent, the metal is completely oxidized to form a metal complete oxide, and the film formation speed further decreases.

As can be seen from FIG. 34, the film-forming speed of metal low-valent oxides is faster than that of metal complete oxides. Therefore, if metal low-valent oxides are used as the light-transmitting medium layer of the resonant structure, productivity can be improved, which is beneficial to reducing costs.

Based on the same concept, embodiments of the present disclosure further provide a projection system, as shown in FIG. 1, the projection system includes: a projection device 2 and a projection screen 1 located on the light-emitting side of the projection device 2.

FIG. 35 is a schematic diagram of a structure of a projection device provided by embodiments of the present disclosure.

As shown in FIG. 35, the projection device includes: a light source device 21, an illumination path 22, a light modulation component 23, and a projection lens 24. The illumination path 22 is located at the light-emitting side of the light source device 21, the light modulation component 23 is located at the light-emitting side of the illumination path 22, and the projection lens 24 is located at the light-emitting side of the light modulation component 23.

The light source device 21 can adopt a laser source device. The laser source device can adopt a monochromatic laser or a laser that can emit laser lights of multiple colors or multiple lasers that emit laser lights of different colors. When the laser source device adopts a monochromatic laser, the laser display device also needs to be provided with a color wheel, which is used for color conversion. The monochromatic laser cooperates with the color wheel to achieve the purpose of emitting primary color lights of different colors in sequence. When the laser source device adopts a laser that can emit laser lights of multiple colors, it is necessary to control the laser source to emit laser lights of different colors as primary color lights in sequence.

In the embodiments of the present disclosure, the light source device can adopt a three-color laser source device, and the three-color laser source device can be a laser that emits three primary color laser lights, such as an MCL laser, etc. The three-color laser source device can also include a red laser, a green laser, and a blue laser that emit three primary color laser lights respectively. The use of the three-color laser source device is conducive to improving the color gamut of the projected image, has better color expression, and can accurately reproduce the input image.

The illumination path 22 is located at the light-emitting side of the light source device 21. The illumination path 22 collimates the output light of the light source device 21 and allows the output light of the light source device 21 to be incident on the light modulation component 23 at a suitable angle. The illumination path 22 can include multiple lenses or lens groups, which are not limited here.

The light modulation component 23 is used to modulate the incident light. In some embodiments, the light modulation component 23 can be a digital micromirror device (DMD). The light modulation component 23 receives the incident light after total reflection by the total reflection prism P, modulates the incident light, and reflects the modulated light. After passing through the illumination path 22, the light beam meets the illumination size and incident angle required by the DMD. The surface of the DMD includes many tiny reflectors, and each tiny reflector can be driven to deflect individually. By controlling the deflection angle of the DMD, the brightness of the light incident on the projection lens 24 is controlled.

The projection lens 24 is used to image the output light of the light modulation component 23. After being imaged by the projection lens 24, the image is projected.

In the embodiments of the present disclosure, the projection device 2 can use an ultra-short-throw projection device, that is, the projection lens 24 in the projection device uses an ultra-short-throw projection lens. The use of an ultra-short-throw projection device can greatly shorten the distance between the projection device 2 and the projection screen 1, and can achieve large-size image display while shortening the projection distance.

The projection screen is located on the light-emitting side of the projection lens in the projection device. The projection screen includes a surface functional layer, a Fresnel lens layer and a reflection layer. The projection screen can adopt any of the above-mentioned projection screens, which can absorb the incident ambient light, improve the black brightness of the projection screen, selectively reflect the incident projection light, absorb light of other bands to improve the contrast of the projection image, and enhance the gain uniformity of the projection screen.

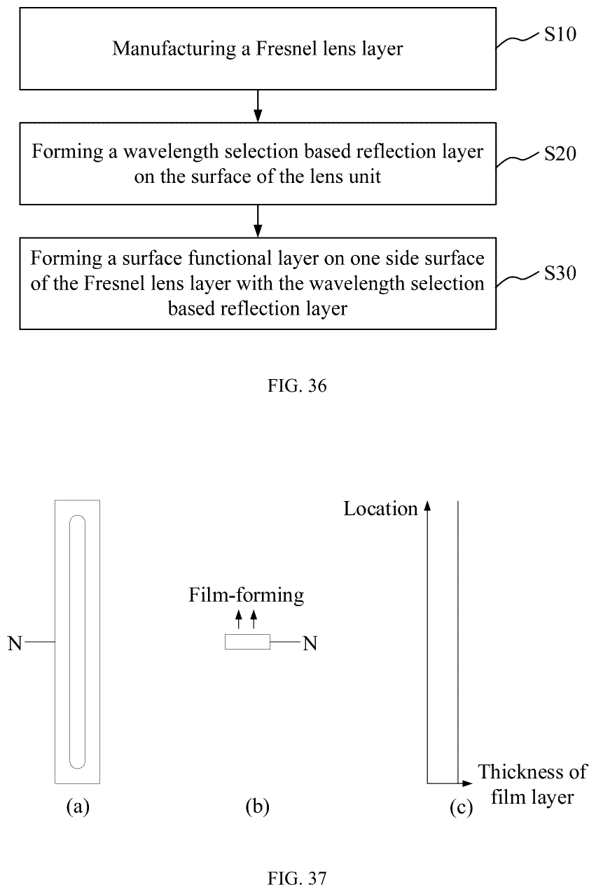

According to another aspect of embodiments of the present disclosure, a method for manufacturing a projection screen is provided. FIG. 36 is a flowchart of a method for manufacturing a projection screen provided by embodiments of the present disclosure.

As shown in FIG. 36, the method for manufacturing a projection screen includes the following steps.

S10, manufacturing a Fresnel lens layer.

S20, forming a wavelength selection based reflection layer on the surface of the lens unit.

S30, forming a surface functional layer on one side surface of the Fresnel lens layer with the wavelength selection based reflection layer.

In some embodiments, the Fresnel lens layer can be formed by a UV molding process. A UV curable resin can be coated on a mold having a lens unit shape on the surface, and then the UV curable resin is pressed against the substrate at a set pressure, and UV irradiation is performed from one side of the substrate to cure the UV curable resin. The UV curable resin is tightly bonded to the substrate while being cured, so that the shape of the lens unit of the mold is transferred to the substrate to form a Fresnel lens layer.

In some embodiments, the integrally formed Fresnel lens layer may also be manufactured by a thermoforming method, where a heated mold having a Fresnel structure is used to thermoform a thermoplastic material layer, thereby forming the Fresnel lens layer.

The Fresnel lens layer manufactured by the above method has a plurality of lens units on one side surface, and each lens unit can be arranged in a concentric circle in a radially expanding manner. Each lens unit includes a lens surface and a non-lens surface connected to each other, and the lens surface is inclined at an angle such that the projection light incident on the reflection layer on the lens surface is reflected toward the viewer.

The wavelength selection based reflection layer can be manufactured by using a coating process such as sputtering or evaporation. Depending on the structure of the projection screen, the manufacturing order of each film layer in the wavelength selection based reflection layer is also different. When the lens unit of the Fresnel lens layer is arranged facing the surface functional layer, the manufacturing order of the wavelength selection based reflection layer is as follows: forming a light reflective layer on the surface of the lens unit of the Fresnel lens layer; forming a light-transmitting medium layer on the surface of the light reflective layer; forming a translucent layer on the surface of the light-transmitting medium layer. When the lens unit of the Fresnel lens layer is arranged away from the surface functional layer, the manufacturing order of the wavelength selection based reflection layer is as follows: forming a translucent layer on the surface of the lens unit of the Fresnel lens layer; forming a light-transmitting medium layer on the surface of the translucent layer; forming a light reflective layer on the surface of the light-transmitting medium layer.

When a sputtering process is used to produce a translucent layer, a light reflective layer and a light-transmitting medium layer, especially when a light-transmitting medium layer is produced, the sputtering device is adjusted in the embodiments of the present disclosure so that the thickness of the film layer finally formed on the lens surface of the lens unit along the direction perpendicular to the plane where the projection screen is located increases with the increase of the radius of each concentric lens unit, while the thickness of the film layer on the lens surface of each lens unit along the direction perpendicular to the lens surface can be equal or approximately equal.

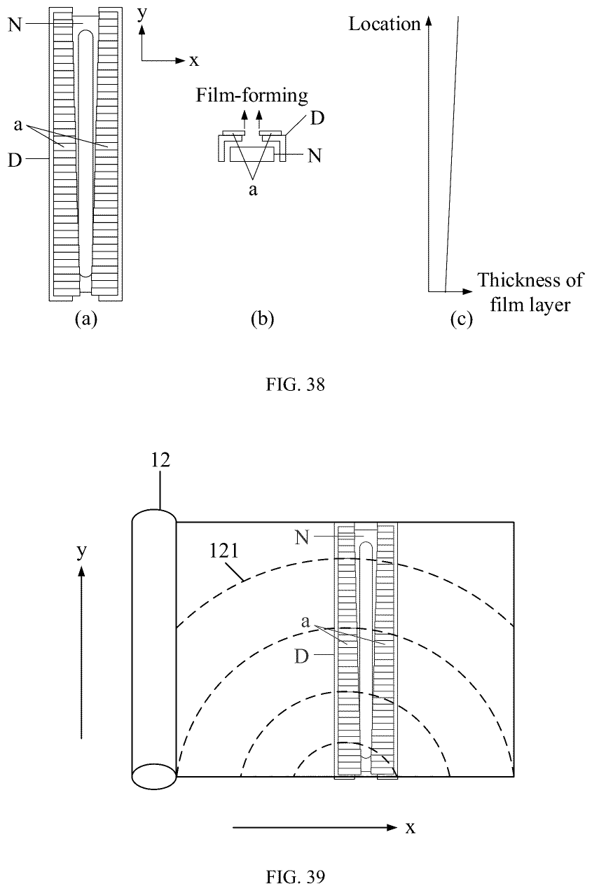

FIG. 37 is a schematic structural diagram of a film-forming cathode portion of a sputtering device in the related art. FIG. 38 is a schematic structural diagram of a film-forming cathode portion of a sputtering device provided by embodiments of the present disclosure. FIG. 39 is a schematic diagram of a sputtering process provided by embodiments of the present disclosure.

Here, (a) in FIG. 37 and FIG. 38 represents the top view structure of the sputtering device, (b) represents the side view structure of the sputtering device, and (c) represents the film layer thickness at different locations.

As shown in (a) and (b) of FIG. 37, in the related art, the plane and cross-section of the sputtering source N in the sputtering device are uniform structures, and the substrate to be coated is arranged above the sputtering source N. As shown in (c) of FIG. 37, the thickness of the film layer formed at different locations on the substrate is also equal.

In order to adjust the thickness of the film layer, in embodiments of the present disclosure, as shown in FIG. 38, a correction plate D is set above the sputtering source N, and the correction plate D includes a plurality of sub-correction plate pairs a. The sub-correction plate pair a includes two sub-correction plates, and a gap of a set distance is provided between the two sub-correction plates; each sub-correction plate pair a is arranged along the second direction y.

As shown in FIG. 39, a flexible material can be used when manufacturing the Fresnel lens layer, so that the formed Fresnel lens layer can be rolled. When the film layer of the wavelength selection based reflection layer is formed by sputtering, the Fresnel lens layer can be rolled so that the lens unit 121 of the Fresnel lens layer 12 is disposed facing the sputtering source N. During the sputtering process, the Fresnel lens layer 12 is rolled so that the Fresnel structure layer 12 moves above the sputtering source N along the first direction x.

As shown in FIG. 39, the first direction x and the second direction y are perpendicular to each other, and the second direction y is perpendicular to the first side of the projection screen, and the first side can be the side to which the centers of the concentric lens units are close. When the projection device is set at the bottom of the projection screen, the second direction y is perpendicular to the bottom side of the projection screen. In the embodiments of the present disclosure, each sub-correction plate pair a is arranged along the second direction, and the gap of each sub-correction plate pair a increases with the increase of the radius of each concentric lens unit. The film thickness of the sputtering source is greater at the location where the gap of the sub-correction plate pair a is larger, and the film thickness of the sputtering source is smaller at the location where the gap of the sub-correction plate pair a is smaller, thereby making the thickness of the light-transmitting medium layer formed on the surface of the lens unit perpendicular to the plane where the projection screen is located gradually increase from the bottom to the top of the projection screen, so that the thickness of the light-transmitting medium layer on the reflection surface of each lens unit perpendicular to the reflection surface can be equal or approximately equal, so that the chromaticity uniformity of the projection screen is better.

In some embodiments, the gap width of each sub-correction plate pair a can be set according to the inclination angle of the lens surface of the corresponding lens unit, but the width of the lens unit is usually tens of microns to hundreds of microns, so it is difficult to set the width of the sub-correction plate pair a according to such a size. In the embodiments of the present disclosure, one sub-correction plate pair a can correspond to multiple lens units, and the gap width of the sub-correction plate pair a can be set according to the average value of the inclination angles of the lens surfaces of the corresponding multiple lens units.

Finally, a surface functional layer is formed on one side of the Fresnel lens layer having the wavelength selection based reflection layer. The surface functional layer can have the effects of expanding the viewing angle, resisting ambient light reflection, resisting ceiling reflection, etc. And the surface functional layer can be located on different sides of the Fresnel lens layer.

In some embodiments, the surface functional layer can be located on the side of the Fresnel lens layer away from the lens unit. In this case, the surface functional layer can include a substrate and a diffusion layer formed on the surface of the substrate. The projection screen is formed by bonding the substrate of the surface functional layer to the Fresnel lens layer. Alternatively, a substrate containing a diffusion material can be directly used as the surface functional layer and bonded to the Fresnel lens layer to form a projection screen. Alternatively, the surface of the substrate can be directly sandblasted to form the surface functional layer, and then the substrate and the Fresnel lens layer are bonded to form a projection screen. This is not limited here.

In some embodiments, the surface functional layer can also be located on the wavelength selection based reflection layer on the surface of the lens unit. In this case, the surface functional layer can be manufactured by directly performing sandblasting on the wavelength selection based reflection layer, which is not limited here.

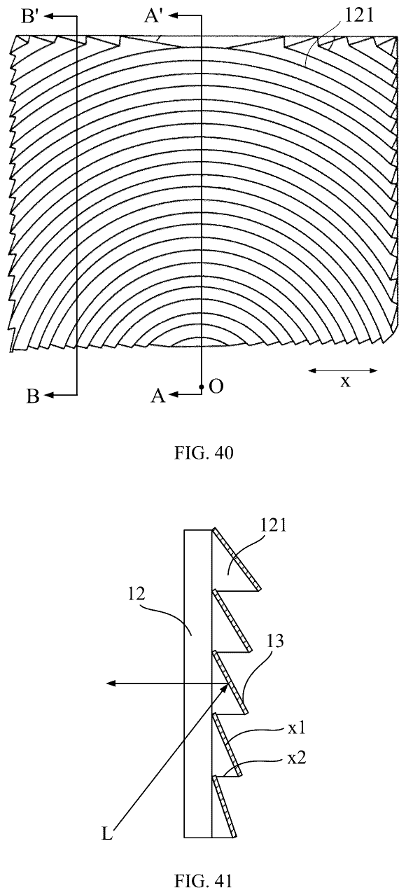

As described above, when the projection system is applied to application scenarios such as laser TV, the projection device can adopt an ultra-short-throw projection device. As shown in FIG. 40, in the projection screen used with the ultra-short-throw projection device, the center O of the lens unit 121 is usually not located inside the projection screen, but in an area outside the projection screen. The side of the projection screen close to the center O is usually the bottom side of the screen, and the radius of each lens unit 121 gradually increases as it gradually moves away from the bottom side. If the side of the projection screen facing the audience is called the front side, and the side away from the audience is called the back side, then in some embodiments, each lens unit 121 is located on the back side of the projection screen. Arranging each lens structure on the back side of the projection screen can reduce the risk of contamination and damage caused by user contact and ensure the long-term reliability of the Fresnel lens layer.

The following will take the projection screen used with the ultra-short-throw projection device as an example to specifically describe the structure and manufacturing method of the projection screen. However, the manufacturing method of the projection screen provided in the embodiments of the present disclosure is not limited to manufacturing the screen of the ultra-short-throw projection device. The manufacturing method can also manufacture screens of different types of projection devices such as short-throw and long-throw. In the specific implementation, only the relevant parameters need to be adaptively adjusted.

FIG. 41 is a schematic diagram of a cross-sectional structure along an A-A′ direction in FIG. 2. The A-A′ direction coincides with the symmetry axis of the projection screen along the vertical direction. The projection screen provided in the embodiments of the present disclosure is an axisymmetric structure, and its symmetry axis is parallel to the vertical direction. When in use, the projection screen is usually set on a wall or hung at a high place, and the bottom edge of the projection screen is parallel to the horizontal direction, then the vertical direction is a direction perpendicular to the horizontal direction, and the extension line of the symmetry axis of the projection screen along the vertical direction passes through the center O of the lens structure.

As shown in FIG. 41, a Fresnel lens layer 12 is provided in the projection screen. The surface of the Fresnel lens layer 12 on one side facing away from the projection device includes a plurality of lens units 121. In the cross section along the A-A′ direction in FIG. 10, the shape of each lens unit 121 is similar to a triangle. Each lens unit 121 includes a lens surface x1 and a non-lens surface x2 connected to each other. The lens surface x1 is inclined relative to the plane where the projection screen is located, and the non-lens surface x2 is used to connect the lens surface x1. The inclination angle of the lens surface x1 of each lens unit 121 is designed according to the incident angle of the projection light, and the inclination angle satisfies that the projection light L can be reflected in the direction of the audience when it is incident on the reflection layer 13 on the surface of the lens surface x1. In this way, more projection light can be reflected in the direction of the audience, while reducing the reflection of ambient light in the direction of the audience, thereby improving the brightness and contrast of the projection picture.

When making a reflection layer on the surface of the Fresnel lens, according to the original design, it is hoped that the reflection layer will be formed only on the lens surface x1 of the lens unit, and not on the non-lens surface x2. The reflection layer is usually made by evaporation or sputtering, but the current reflection layer manufacturing process will not only form a reflection layer on the lens surface x1 of the lens unit, but also on the non-lens surface x2, which will cause light to be reflected when it enters the non-lens surface x2, which is inconsistent with the original design.

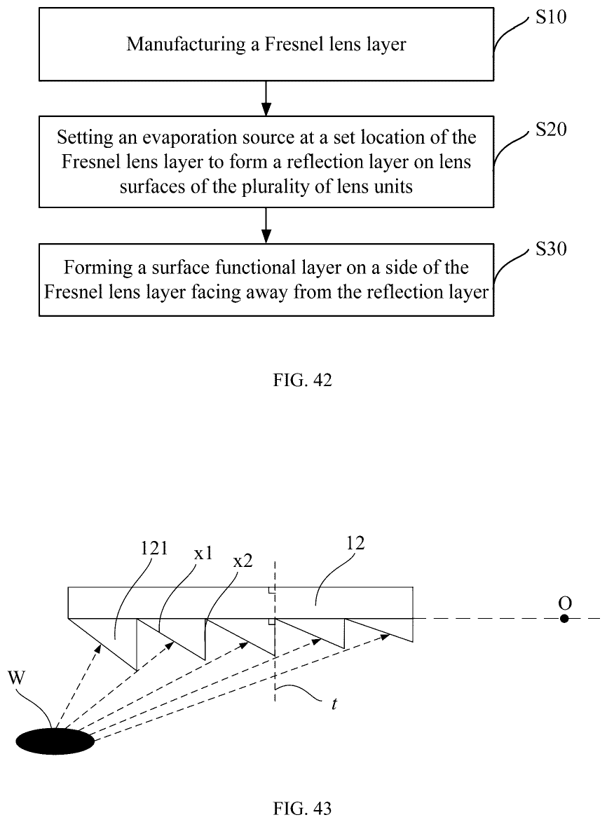

In view of this, embodiments of the present disclosure provide a method for manufacturing a projection screen. FIG. 42 is a second flowchart of a method for manufacturing a projection screen provided by embodiments of the present disclosure.

As shown in FIG. 42, the method for manufacturing a projection screen includes the following steps.

S10, manufacturing a Fresnel lens layer.

S20, setting an evaporation source at a set location of the Fresnel lens layer to form a reflection layer on lens surfaces of the plurality of lens units.

S30, forming a surface functional layer on a side of the Fresnel lens layer facing away from the reflection layer.

In the embodiments of the present disclosure, for example, the reflection layer is made by using the evaporation process for specific description. In addition to the evaporation process, the reflection layer can also be made by sputtering or similar processes. The reflection layer can be made of a metal material with reflective properties, such as aluminum, silver, titanium, etc. In addition, the reflection layer can also adopt a multi-layer structure, which can achieve selective reflection of the incident light, thereby further improving the contrast of the projected image.

By improving the structure and location of the evaporation source in the embodiments of the present disclosure, the reflection layer can be formed only on the lens surface of the lens unit, avoiding the reflection layer from being formed on the non-lens surface of the lens unit. The production process of the projection screen is described in detail below.

The Fresnel lens layer 12 can include a substrate and a lens unit 121 located on the substrate, where the lens unit 121 can be manufactured by using a mold having a Fresnel lens and a UV molding process using an ultraviolet curing resin.

Before manufacturing the reflection layer 13 on the surface of the lens unit 121, it is necessary to design the structure and the location of the evaporation source, and the design can be in various forms.

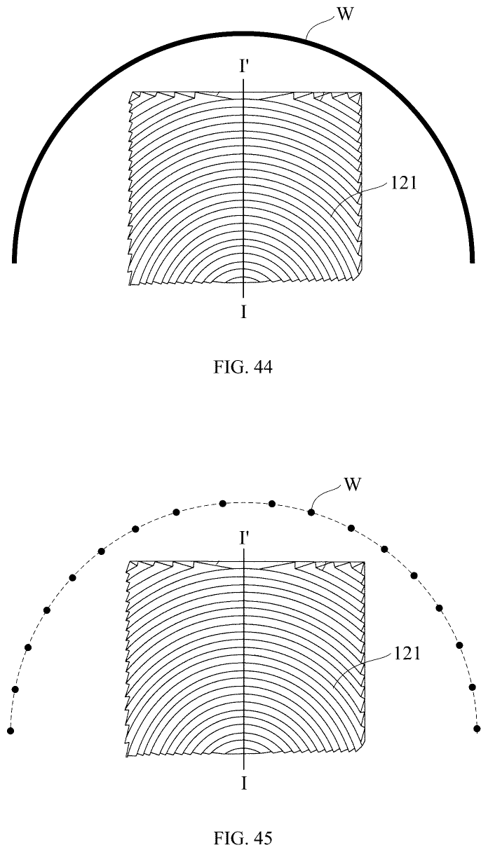

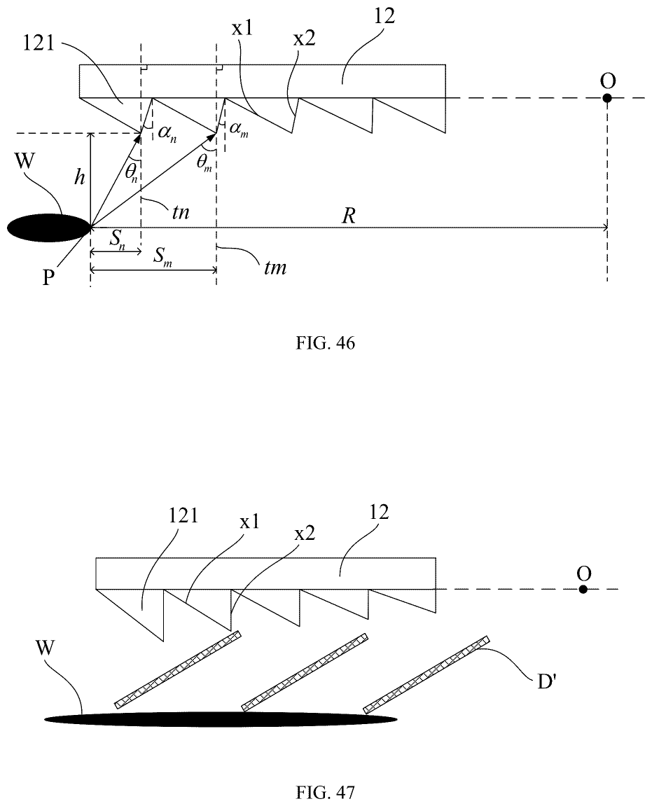

FIG. 43 is a schematic diagram of a cross-sectional structure of a locational relationship between an evaporation source and a Fresnel lens layer provided by embodiments of the present disclosure. FIG. 44 is a first schematic diagram of a planar structure of a locational relationship between an evaporation source and a Fresnel lens layer provided by embodiments of the present disclosure. FIG. 45 is a second schematic diagram of a planar structure of a locational relationship between an evaporation source and a Fresnel lens layer provided by embodiments of the present disclosure. FIG. 46 is a schematic diagram of a cross-sectional structure along an I-I′ direction in FIG. 44.

As shown in FIG. 43, the evaporation source W is disposed on a side of the Fresnel lens layer 12 having the lens unit 121, and there is a certain distance between the evaporation source W and the lens unit 121. The evaporation source radiates the evaporation material isotropically in a working state.

In some embodiments, as shown in FIGS. 44 and 45, at least one evaporation source W arranged in an arc shape can be used when manufacturing the reflection layer. As shown in FIG. 44, the number of evaporation sources W can be one, and the size of the evaporation source W is relatively large, and the shape is a section of an arc; or, as shown in FIG. 45, the number of evaporation sources W is multiple, the size of the evaporation source W is relatively small, and the evaporation sources W are arranged in a section of an arc.

The evaporation source will isotropically radiate the evaporation material when evaporating the reflection layer. The evaporation source W is arranged in an arc shape so that the orthographic projection of the circle center of the evaporation source W on the plane where the projection screen is located coincides with the circle center of the lens unit 121, so that the evaporation material can be relatively evenly formed on the lens unit 121.

In order to prevent the evaporation source W from forming the evaporation material on the non-lens surface x2 of the lens unit 121, when the radius of the evaporation source W arranged in an arc shape is larger than the radius of any lens unit 121 in the Fresnel lens layer, only the evaporation material emitted from the evaporation source W toward the side of the center O will be incident on the lens surface x1 of the lens unit 121, thereby preventing the evaporation material from being incident on the non-lens surface x2 of the lens unit 121.

FIGS. 44 and 45 illustrate an example in which the evaporation source W is arranged in the form of a circular arc. In a specific implementation, the evaporation source W can also be arranged in the form of multiple circular arcs. In this case, multiple evaporation sources are required. In some embodiments, the size of the evaporation source is relatively large, and the shape of each evaporation source is a circular arc. Multiple evaporation sources can be arranged in the form of multiple concentric arcs. In some embodiments, the size of each evaporation source is relatively small. These evaporation sources are arranged in multiple circular arcs, and each circular arc is formed by arranging multiple evaporation sources.

When the evaporation source is arranged in multiple arcs, each arc can be arranged concentrically, and the radius of each arc needs to be greater than the radius of any lens unit 121 in the Fresnel lens layer. According to this design concept, the minimum radius of the evaporation source arranged in an arc shape can be determined.

Specifically, as shown in FIG. 46, in the order of the radius of each lens unit 121 from small to large, the inclination angle of the non-lens surface of the m-th lens unit relative to the normal line tm is αₘ, and the inclination angle of the non-lens surface of the n-th lens unit relative to the normal line tn is αₙ. In the cross section shown in FIG. 46, the inclination angle of the line connecting the innermost point P of the evaporation source and the vertex of the m-th lens unit relative to the normal line tm is θₘ, and the inclination angle of the line connecting the evaporation source W and the vertex of the n-th lens unit relative to the normal line tn is θₙ; the vertical distance from the plane including the innermost point P of the evaporation source to the vertex of the lens unit 121 is h, the distance from the innermost point P of the evaporation source to the normal tm passing through the vertex of the m-th lens unit is Sₘ, and the distance from the innermost point P of the evaporation source to the normal line tn passing through the vertex of the n-th lens unit is Sₙ.

Here, the normal lines tₘ and tₙ are the normal lines of the plane where the projection screen is located, and the normal lines t in the embodiments of the present disclosure are perpendicular to the plane where the projection screen is located. The Fresnel lens layer 12 shown in FIG. 46 includes a substrate, and the plane where the projection screen is located can be parallel to the plane where the substrate of the Fresnel lens layer 12 is located. Therefore, the plane where the projection screen is located in the embodiments of the present disclosure can refer to the plane where the Fresnel lens layer 12 is located in FIG. 46, and the normal line of the plane where the projection screen is located is referred to as the normal line hereinafter.

As shown in FIG. 44, from the perspective of the planar structural relationship, the evaporation source is arranged in an arc shape, and the orthographic projection of the circle center of the evaporation source arranged in an arc shape on the plane where the projection screen is located is coincident with the circle center of the arc lens unit, and the radius of the evaporation source arranged in an arc shape is greater than the radius of all the circular lens units. The evaporation source W usually radiates isotropically when emitting the evaporation material. When the side of the evaporation source W emitting the evaporation material is arranged opposite to the side of the Fresnel lens layer 12 having the lens unit 121, as shown in FIG. 44, only the evaporation material emitted from the innermost periphery of the evaporation source W can be incident on the lens unit 121. Then, in the cross section along the radial direction, as shown in FIG. 46, the innermost point P of the evaporation source refers to the point of the evaporation source closest to the center O in the cross section, that is, the rightmost point of the evaporation source in FIG. 46. It can be seen from FIG. 46 that in the cross-section along any radial direction, the inclination angle of the evaporation material emitted from the innermost point P of the evaporation source relative to the normal line when it is incident on the vertex of the lens unit is usually smaller than the inclination angle of the evaporation material emitted from other locations of the evaporation source relative to the normal line when it is incident on the vertex of the same lens unit. Therefore, the minimum inclination angle formed by the line connecting the innermost point P of the evaporation source and the vertex of the lens unit 121 is taken into consideration.

As shown in FIG. 46, the vertex of the lens unit 121 refers to an intersection of the lens surface x1 and the non-lens surface x2 of the lens unit 121 on the side close to the evaporation source W in any cross section.

According to the trigonometric function relationship:

$${θ}_{m} = {tan}^{- 1} ( \frac{{S}_{m}}{h} ) ;$$

$${θ}_{n} = {tan}^{- 1} ( \frac{{S}_{n}}{h} ) .$$

In order to prevent the evaporation material emitted by the evaporation source W from being formed on the non-lens surface x2 of the Fresnel lens, αₘ<θₘ needs to be satisfied for the m-th lens unit, and αₙ<θₙ needs to be satisfied for the n-th lens unit. Then, when the evaporation source W satisfies the above relationship for each lens unit 121, the minimum radius R that the evaporation source W set in an arc shape should satisfy can be found.

FIG. 46 is a schematic diagram of using an arc-shaped evaporation source, and the cross section shown in FIG. 46 is a cross section along the symmetry axis I-I′ direction of the projection screen. When more arc-shaped evaporation sources are used or the evaporation sources are arranged into multiple concentric arcs, the cross section of each arc along any radial direction satisfies:

$${α}_{i} < {θ}_{i} = {tan}^{- 1} ( \frac{{S}_{i}}{h} ) . \qquad ( 1 )$$

Here, ai represents the inclination angle of the non-lens surface of the i-th lens unit 121 relative to the normal line of the plane where the projection screen is located in the cross section along any radial direction of the Fresnel lens layer, θᵢ represents the inclination angle of the line connecting the innermost point of the evaporation source and the vertex of the i-th lens unit 121 in the cross section relative to the normal line. Sᵢ represents the distance from the innermost point of the evaporation source in the cross section to the normal line passing through the vertex of the i-th lens unit, and h represents the distance from the plane including the innermost point of the evaporation source to the vertex of the lens unit 121.

The definitions of the normal line, the innermost point of the evaporation source in the cross section, and the vertex of the lens unit can refer to the above embodiments and will not be repeated here. Referring to FIG. 46, the plane including the innermost point P of the evaporation source refers to the plane passing through point P and parallel to the plane where the projection screen is located.

The location of the evaporation source satisfies that the inclination angle of the line connecting the vertices of any lens unit with respect to the normal line of the plane where the projection screen is located is greater than the inclination angle with respect to the non-lens surface of the lens unit. Therefore, when the evaporation source radiates the evaporation material to the Fresnel lens layer, the evaporation material can be prevented from being incident on the non-lens surface of each lens unit.

In some embodiments, the inclination angle of the lens surface x1 of each lens unit 121 in the Fresnel lens layer 12 relative to the plane where the projection screen is located, and the inclination angle of the non-lens surface x2 of each lens unit 121 relative to the normal line of the plane where the projection screen is located may vary. Then the evaporation source needs to be set according to the actual situation.

Specifically, when the projection screen is used in an ultra-short-throw projection system, the projection device is usually located below the projection screen, and the projection light is emitted obliquely upward to the projection screen. If the projection light is to be reflected in the direction of the audience, the inclination angle of the lens surface x1 of each lens unit 121 in the Fresnel lens layer 12 relative to the plane where the projection screen is located satisfies: the inclination angle of the lens surface x1 increases with the increase of the radius of the lens unit. As shown in FIGS. 43 and 46, in the projection screen used in the ultra-short-throw projection system, the center O of the Fresnel lens is located outside the projection screen, and in the cross-sectional structure schematic diagrams shown in FIGS. 43 and 46, the farther from the center O, the greater the inclination angle of the lens surface x1 of the lens unit 121 relative to the plane where the projection screen is located.

For the non-lens surface x2 of each lens unit 121, its inclination angle relative to the normal line of the plane where the projection screen is located can change with the lens surface x1, or can remain unchanged.

In some embodiments, as shown in FIG. 43, the non-lens surface x2 of each lens unit 121 has the same inclination angle relative to the normal line t of the plane where the projection screen is located. For example, the non-lens surface x1 of each lens unit 121 is perpendicular to the plane where the projection screen is located, that is, αᵢ=0 in the above formula (1). Then the location of the evaporation source W arranged in an arc shape satisfies that in any cross section along the radial direction, the inclination angle of the connection between the innermost point of the evaporation source W and the vertex of any lens unit 121 in the cross section relative to the normal line of the plane where the projection screen is located is greater than 0, that is, 0ᵢ>0 in the above formula (1).

In some embodiments, as shown in FIG. 46, the inclination angle of the non-lens surface x2 of each lens unit 121 relative to the normal line t of the plane where the projection screen is located increases as the radius of the lens unit 121 increases, that is, αₙ>αₘ in the cross-sectional view shown in FIG. 46. Then, when the evaporation source W is set for this situation, the maximum value of the inclination angles of the non-lens surface x2 in the Fresnel lens layer 12 relative to the normal line of the plane where the projection screen is located is the inclination angle of the non-lens surface of the lens unit with the largest radius. Therefore, the evaporation source W satisfies that the inclination angle of the line connecting the innermost point of the evaporation source and the vertex of the lens unit with the largest radius relative to the normal line in the cross section along any radial direction of the Fresnel lens layer is greater than the inclination angle of the non-lens surface of the lens unit with the largest radius relative to the normal line, and the above normal lines are all normal lines to the plane where the projection screen is located.

In a specific implementation, the distance between the evaporation source and the Fresnel lens layer can be 100 mm to 1000 mm, the width of the evaporation source arranged in an arc shape can be 20 mm to 300 mm, and the spacing between two adjacent circular evaporation sources can be within 300 mm. For example, the vertical distance between the evaporation source and the Fresnel lens layer can be 300 mm, the width of the evaporation source arranged in an arc shape can be 100 mm, and the spacing between two adjacent circular evaporation sources can be 20 mm.

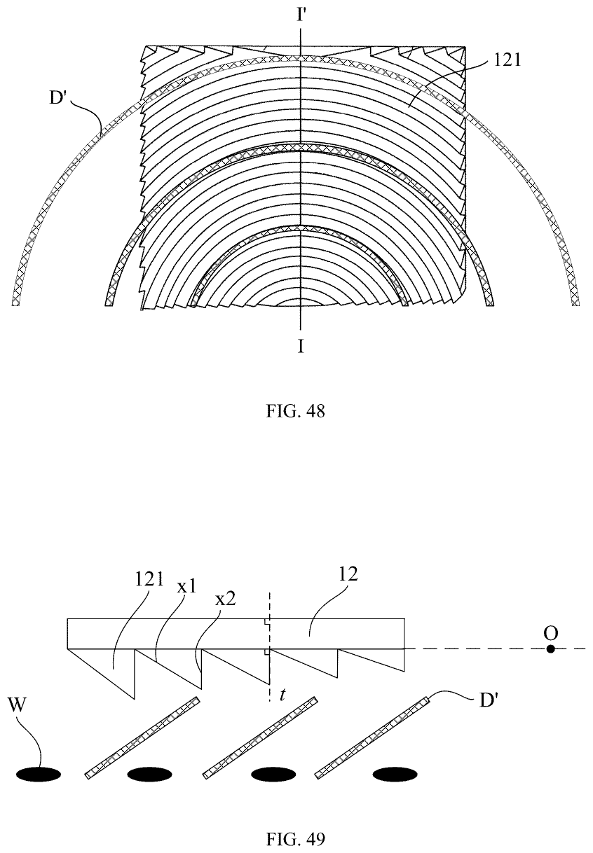

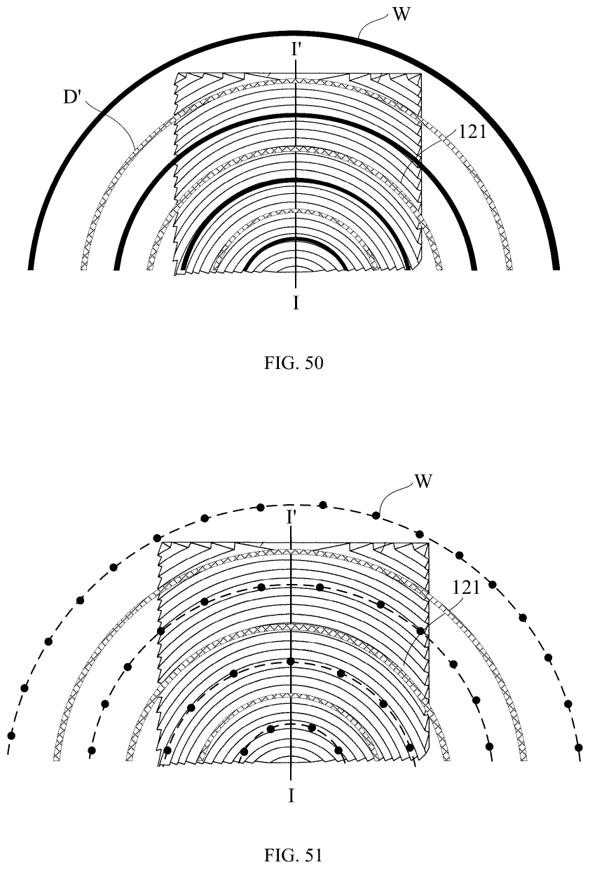

FIG. 47 is a schematic cross-sectional view showing a locational relationship among an evaporation source, a baffle and a Fresnel lens layer provided by embodiments of the present disclosure. FIG. 48 is a schematic diagram of a planar structure of a locational relationship between a baffle and a Fresnel lens layer provided by embodiments of the present disclosure. FIG. 49 is a second schematic diagram of a cross-sectional structure of a locational relationship among an evaporation source, a baffle and a Fresnel lens layer provided by embodiments of the present disclosure. FIG. 50 is a first schematic diagram of a planar structure of a locational relationship among an evaporation source, a baffle and a Fresnel lens layer provided by embodiments of the present disclosure. FIG. 51 is a second schematic diagram of a planar structure of a locational relationship among an evaporation source, a baffle and a Fresnel lens layer provided by embodiments of the present disclosure.

In some embodiments, as shown in FIG. 47, a evaporation source W can be disposed on one side of the Fresnel lens layer 12 having a plurality of lens units 121, so that a set distance exists between the evaporation source W and the plurality of lens units 121; and a plurality of spaced-apart baffles D′ can be disposed between the evaporation source W and the plurality of lens units 121, so that the baffles D′ block the evaporation material emitted from the evaporation source W from being formed on the non-lens surface x2 of the lens unit 121.

Specifically, a plurality of baffles D′ are arranged between the evaporation source W and the Fresnel lens layer 12, which can block the evaporation source W from emitting the evaporation material onto the non-lens surface x2 of the lens unit 121. Since the lens surface and the non-lens surface of the lens unit 121 may have different inclination angles, the baffle D′ usually needs to be arranged at an inclination, and the inclination angles of the baffles at different locations can be different. The inclination angle of each baffle needs to be set according to the standard that the evaporation material emitted by the evaporation source near it is not formed on the non-lens surface x of the lens unit 121 at the corresponding location after being blocked by the baffle D′. In some embodiments, the width of the lens unit 121 is in the micrometer range, and the spacing distance of the baffle D′ can be tens of millimeters or more. The scheme of using the evaporation source W and the baffle D′ to cooperate with each other can make the distance between the evaporation source W and the Fresnel lens layer 12 not too large, and can avoid the uneven evaporation caused by the long distance between the evaporation source W and the remote lens unit.

The evaporation source W can be arranged in an arc shape, and accordingly, the shape of the baffle D′ is a part of a conical surface, as shown in FIG. 48, which is a planar structure of the baffle D′, and the overall contour of the baffle D′ in the planar structure is an arc shape. From the perspective of the three-dimensional structure, the orthographic projection of the vertex of the conical surface where the baffle D′ is located on the plane where the projection screen is located coincides with the circle center of the lens unit 121.

In some embodiments, as shown in FIG. 47, the evaporation source W may have a relatively large width. In this case, only one evaporation source W needs to be set up. The evaporation source W may correspond to a plurality of baffles D′, thereby reducing the number of evaporation sources W used.

In some embodiments, as shown in FIG. 49, the evaporation source W may have a relatively small width and a plurality of evaporation sources. In this case, a baffle D′ can be provided between each two adjacent evaporation sources W, thereby enabling a more sophisticated design of the evaporation source and the baffle. In some embodiments, as shown in FIG. 50 and FIG. 51, the evaporation source W can be provided in a plurality of arcs. Referring to FIG. 50, the number of evaporation sources W can be multiple, each evaporation source W is in the shape of an arc, and each arc-shaped evaporation source W can be concentrically arranged. Alternatively, referring to FIG. 51, the number of evaporation sources W can be multiple, and each evaporation source W is discretely arranged, and these evaporation sources W are dispersedly arranged into a plurality of concentrically arranged arcs, and each arc is formed by the arrangement of a plurality of evaporation sources.

In order to prevent the evaporation material from being formed on the non-lens surface x2 of each lens unit 121, the baffle D′ has a certain inclination angle. The inclination angle satisfied by the baffle is specifically described below.

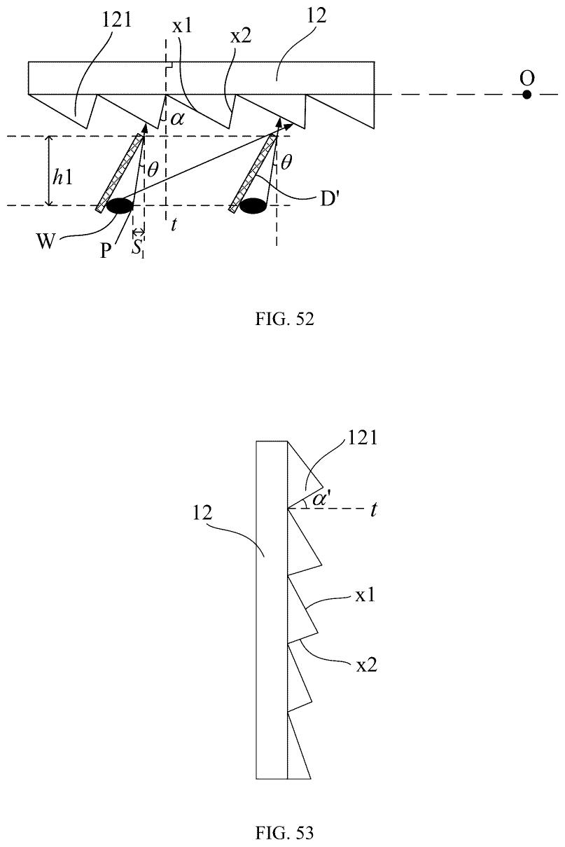

FIG. 52 is a third schematic diagram of a cross-sectional structure of a locational relationship among an evaporation source, a baffle and a Fresnel lens layer provided by embodiments of the present disclosure. FIG. 52 shows a cross-sectional structure along the I-I′ direction in FIG. 50. As shown in FIG. 52, the non-lens surface x2 of the lens unit 121 has an inclination angle α relative to the normal line t of the plane where the projection screen is located. In the cross section shown in FIG. 52, the inclination angle of the line connecting the innermost point P of the evaporation source and the edge of the baffle D′ corresponding thereto close to the Fresnel lens layer relative to the normal line t is θ. In the cross section shown in FIG. 52, the vertical distance from the innermost point P of the evaporation source to the normal line of the edge passing through the baffle D′ close to the Fresnel layer is S₁, and the distance from the plane including the innermost point of the evaporation source to the edge of the baffle D′ close to the Fresnel lens layer is h₁.

The definitions of the normal line, the innermost point of the evaporation source in the cross section, and the plane including the innermost point of the evaporation source may refer to the above embodiments and will not be repeated here.

According to the trigonometric function relationship:

$$θ = {tan}^{- 1} ( \frac{{S}_{1}}{{h}_{1}} ) .$$

Here, the function of the baffle D′ is to block the evaporation material from being incident on the non-lens surface x2 of the lens unit 121, so the baffle is usually inclined toward the center O of the lens unit 121. Then, in order to enable the baffle D′ to block the evaporation source W from emitting the evaporation material to the non-lens surface x2 of the lens unit 121, it is necessary to make the minimum inclination angle of the line connecting the innermost point of any evaporation source in the cross section along any radial direction of the Fresnel lens layer to the edge of the corresponding baffle close to the Fresnel lens layer relative to the normal line of the plane where the projection screen is located be greater than the maximum inclination angle of the non-lens surface x2 of the lens unit 121 relative to the normal line.

FIG. 52 illustrates a cross section along the symmetry axis I-I′ of the projection screen. When setting the inclination angle of the baffle, it is necessary to ensure that the inclination angle of the baffle in the cross section along any radial direction of the Fresnel lens layer satisfies:

$${α}_{max} < θ = {tan}^{- 1} ( \frac{{S}_{1}}{{h}_{1}} ) . \qquad ( 2 )$$

Here, αₘₐₓ represents the maximum inclination angle of the non-lens surface of the lens unit in the cross section along any radial direction of the Fresnel lens layer relative to the normal line of the plane where the projection screen is located, θ represents the minimum inclination angle of the connecting line between the innermost point of the evaporation source and the edge of the baffle plate close to the Fresnel lens layer in the cross section relative to the normal line, S₁ represents the distance from the innermost point of the evaporation source in the cross section to the normal line of the edge passing through the baffle plate close to the Fresnel lens layer, and h₁ represents the distance from the plane including the innermost point of the evaporation source to the edge of the baffle plate close to the Fresnel lens layer.

The definitions of the normal line, the innermost point of the evaporation source in the cross section, and the plane including the innermost point of the evaporation source may refer to the above embodiments and will not be repeated here.

As described above, the inclination angle of the lens surface x1 of each lens unit 121 in the Fresnel lens layer 12 relative to the plane where the projection screen is located, and the inclination angle of the non-lens surface x2 of each lens unit 121 relative to the normal line of the plane where the projection screen is located may vary. Still taking the projection screen used in the ultra-short-throw projection system as an example, the inclination angle of the lens surface x1 of each lens unit 121 in the Fresnel lens layer 12 relative to the plane where the projection screen is located increases with the increase of the radius of the lens unit 121. For the non-lens surface x2 of each lens unit 121, its inclination angle relative to the normal line of the plane where the projection screen is located may change with the lens surface x1, or may remain unchanged.

In some embodiments, as shown in FIG. 49, the non-lens surface x2 of each lens unit 121 has the same inclination angle relative to the normal line t of the plane where the projection screen is located. For example, the non-lens surface x1 of each lens unit 121 is perpendicular to the plane where the projection screen is located, that is, α in the above formula (2) satisfies α=0. In this case, the inclination angles of the baffles D′ located between the evaporation source W and the Fresnel lens layer 12 can be the same, and the baffles D′ are parallel to each other.

In some embodiments, as shown in FIG. 52, the inclination angle of the non-lens surface x2 of each lens unit 121 relative to the normal line t of the plane where the projection screen is located increases as the radius of the lens unit 121 increases, that is, the larger the radius of the lens unit 121, the larger the inclination angle of the non-lens surface x2 of the lens unit 121 relative to the normal line. In this case, the inclination angle of the baffle D′ needs to be set according to the lens unit 121 to which it corresponds. The width of the lens unit 121 is usually in the micrometer order, while the width of the baffle D′ is usually in the millimeter order. Therefore, one baffle D′ corresponds to multiple lens units 121. According to the above formula (2), the angle of the line connecting the edge of the baffle D′ close to the Fresnel lens layer and the innermost point of the corresponding evaporation source relative to the normal line needs to be greater than the maximum angle of the non-lens surface x2 of each lens unit 121 corresponding to the baffle D′ relative to the normal line.

In a specific implementation, the distance between the evaporation source and the Fresnel lens layer can be 20 mm to 200 mm, the evaporation source is arranged close to the side of the baffle away from the Fresnel lens layer, the width of the baffle can be 100 mm to 500 mm, and the spacing between adjacent baffles can be 50 mm to 200 mm. For example, the distance between the evaporation source and the Fresnel lens layer can be 100 mm, the width of the baffle can be 200 mm, and the spacing between adjacent baffles can be 100 mm.

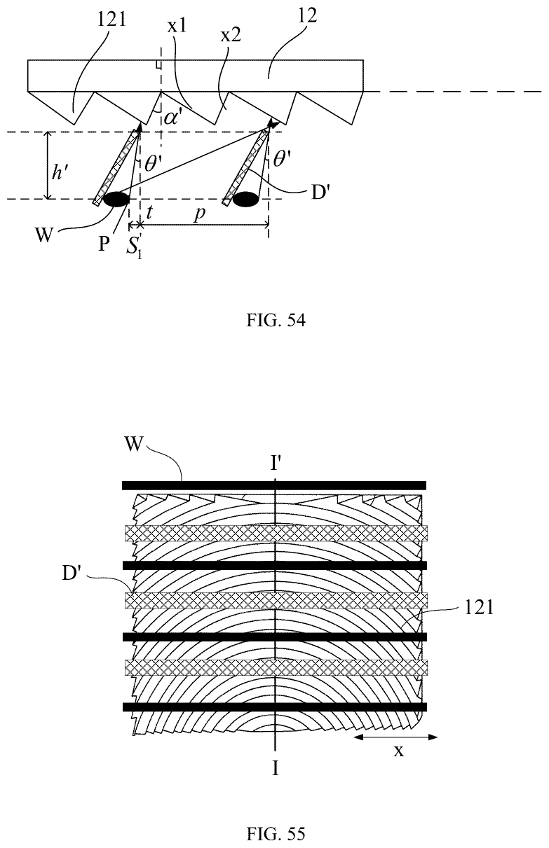

FIG. 53 is a schematic diagram of a cross-sectional structure along a B-B′ direction in FIG. 40. FIG. 54 is a schematic diagram showing a locational relationship among an evaporation source, a baffle and a Fresnel lens layer along a cross section shown in FIG. 53. The B-B′ direction and the A-A′ direction in FIG. 40 are parallel to each other, that is, they are both parallel to the symmetry axis I-I′ of the projection screen along the vertical direction.

In some embodiments, as shown in FIGS. 53 and 54, a evaporation source W can be set on one side of the Fresnel lens layer 12 having multiple lens units 121, so that the evaporation source W and the multiple lens units 121 are at a set distance; and a plurality of spaced-apart baffles D′ are set between the evaporation source W and the multiple lens units 121, so that the baffles D′ block the evaporation material emitted by the evaporation source W from forming on the non-lens surface x2 of the lens unit 121.

The difference from the embodiment shown in FIG. 54 is that the cross section shown in FIG. 54 is a cross section along the B-B′ direction in FIG. 40. When all cross sections of the Fresnel lens layer are cut along the direction parallel to the B-B′ direction in FIG. 40, the size of the inclination angle α′ of the non-lens surface x2 of the lens unit 121 relative to the normal line t of the plane where the projection screen is located will vary. If the maximum inclination angle αₘₐₓ′ of the non-lens surface x2 of the lens unit 121 relative to the normal line of the plane where the projection screen is located is found in a certain cross section, then the locational relationship between the baffle D′ and its corresponding evaporation source W can satisfy:

$${α}_{max}^{′} < {θ}^{′} = {tan}^{- 1} ( \frac{{S}_{{1}^{′}}}{{h}_{{1}^{′}}} ) . \qquad ( 3 )$$

As shown in FIG. 54, αₘₐₓ′ represents the maximum inclination angle of the non-lens surface x2 of the lens unit 121 obtained in all cross sections of the Fresnel lens layer 12 along the direction parallel to the B-B′ relative to the normal line of the plane where the projection screen is located, θ′ represents the minimum inclination angle of the connecting line between the innermost point P of the evaporation source in the cross section and the edge of the corresponding baffle D′ close to the side of the Fresnel lens layer relative to the normal line t, S₁′ represents the distance from the innermost point P of the evaporation source in the cross section to the normal line t of the edge passing through the baffle D′ close to the side of the Fresnel lens layer, and h₁′ represents the distance from the plane including the innermost point P of the evaporation source to the edge of the baffle close to the side of the Fresnel lens layer.

The normal line is the normal line of the plane where the projection screen is located. The innermost point of the evaporation source refers to the point on the side of the corresponding baffle that the evaporation source is farthest from in the above cross section. For example, in FIG. 54, the left side of the evaporation source W is closer to the baffle D′, and the right side of the evaporation source is farther from the baffle. Therefore, the innermost point of the evaporation source in FIG. 54 refers to the rightmost point of the evaporation source. The plane including the innermost point P of the evaporation source refers to the plane passing through point P and parallel to the plane where the projection screen is located.

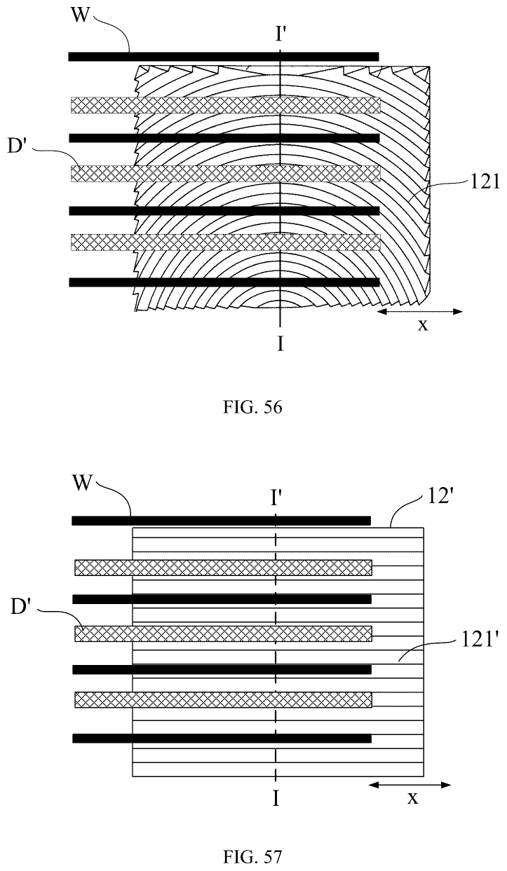

When the locational relationship between the baffle D′ and the corresponding evaporation source W satisfies the above formula (3), the structures of the baffle D′ and the evaporation source W can be simplified. Specifically, FIG. 55 is a third schematic diagram of a planar structure of an evaporation source, a baffle and a Fresnel lens layer provided by embodiments of the present disclosure. FIG. 56 is a fourth schematic diagram of a planar structure of an evaporation source, a baffle and a Fresnel lens layer provided by embodiments of the present disclosure.

At this time, as shown in FIG. 55, the evaporation source W can be set to a strip extending along the first direction x, and the baffle D′ can be set to a strip extending along the first direction x, and the baffle D′ is no longer a complex structure such as a conical surface, but is set to a plane.

The first direction x is parallel to the plane where the projection screen is located and perpendicular to the symmetry axis I-I′ of the projection screen along the vertical direction.

This can simplify the structures of the evaporation source and the baffle while preventing the evaporation material from being formed on the non-lens surface of the lens unit.

Furthermore, as shown in FIG. 56, if the Fresnel lens layer is moved along the first direction x during evaporation, a film can be formed on the lens surface of the lens unit, thereby improving the productivity of the reflection layer. If combined with a roll-to-roll process, the productivity of the projection screen can be further improved.

In a specific implementation, the distance between the evaporation source and the Fresnel lens layer can be 20 mm to 200 mm, the evaporation source is arranged close to the side of the baffle away from the Fresnel lens layer, the width of the baffle can be 100 mm to 500 mm, and the spacing between adjacent baffles can be 50 mm to 500 mm. For example, the distance between the evaporation source and the Fresnel lens layer can be 100 mm, the width of the baffle can be 200 mm, and the spacing between adjacent baffles can be 100 mm.

According to the same concept, when the functional layer in the projection screen no longer uses Fresnel lenses, but is composed of multiple lens structure layers extending along the above-mentioned first direction and arranged along the symmetry axis I-I′ direction along the vertical direction of the projection screen, the structure of the evaporation source and baffle in the above-mentioned embodiment can also be applied.

Specifically, FIG. 57 is a schematic diagram of a planar structure of an evaporation source, a baffle and a lens structure layer provided by embodiments of the present disclosure. As shown in FIG. 57, the projection screen has a lens structure layer 12′, and the lens structure layer 12′ includes a plurality of lens units 121′, and these lens units 121′ are all strips extending along the first direction x, and are arranged along the direction of the symmetry axis I-I′ of the projection screen along each lens unit 121′. Among them, the first direction x is parallel to the plane where the projection screen is located, and the first direction x is perpendicular to the symmetry axis I-I′ of the projection screen along the vertical direction. Similarly, the lens unit 121′ includes a lens surface and a non-lens surface connected to each other, where the lens surface is tilted relative to the plane where the projection screen is located, and the non-lens surface is used to connect the lens surface so that the inclination angle of the lens surface relative to the plane where the projection screen is located satisfies that the projection light incident on the reflection layer on the lens surface can be reflected in the direction where the audience is located.

For the lens structure layer 12′ that meets the above-mentioned lens unit 121′, the evaporation source W and the baffle D′ can both be in the shape of strips extending along the first direction x, and the baffle D′ is a plane. The structures of the lens structure layer 12′, the evaporation source W and the baffle D′ are all simplified.

When all cross sections of the lens structure layer 12′ are cut along the direction parallel to I-I′ in FIG. 57, the cross-sectional structure obtained is the same as the cross-sectional structure obtained along the direction I-I′ in FIG. 57. Therefore, the locational relationship that the baffle D′ and its corresponding evaporation source W should satisfy is the same as the above formula (2), thereby preventing the evaporation material emitted by the evaporation source W from being formed on the non-lens surface of the lens unit 121′.

When the projection screen is applied to an ultra-short-throw projection system, the inclination angle of the lens surface of each lens unit 121′ in the lens structure layer 12′ relative to the plane where the projection screen is located increases as the distance between the lens unit 121′ and the bottom edge of the projection screen increases, as shown in FIG. 57, the bottom edge of the projection screen is the lower side edge in FIG. 57. If the inclination angles of the non-lens surfaces of each lens unit 121′ relative to the normal of the plane where the projection screen is located are the same, for example, the non-lens surfaces of each lens unit 121′ are arranged perpendicular to the plane where the projection screen is located, then the inclination angles of each baffle D′ located between the evaporation source W and the functional layer 12′ can be the same, and the baffles D′ are parallel to each other. If the inclination angle of the non-lens surface of each lens unit 121′ relative to the normal of the plane where the projection screen is located increases as the distance between the lens unit 121′ and the bottom edge of the projection screen increases, then the inclination angle of the baffle D′ needs to be set for the corresponding lens unit 121′, and the baffles D′ are no longer parallel to each other.

In some embodiments, the reflection layer can be a single-layer structure or a multi-layer composite structure. When the reflection layer is a single-layer structure, any of the above methods can be used to evaporate the reflective metal material on the lens surface of the lens unit. When the reflection layer is a multi-layer composite structure, it can achieve selective reflection of light in a specific wavelength band, thereby further improving the contrast of the projected image.

Finally, after the reflection layer is made, the surface functional layer can also be made. The surface functional layer is located on the outermost side of the projection screen, that is, the side closest to the audience. The surface functional layer plays a role in protecting the projection screen. In addition, the surface functional layer can also be processed in a variety of ways according to different needs to achieve the effects of expanding the viewing angle, resisting ambient light reflection, and resisting ceiling reflection.

What is claimed is:

1. A projection screen, comprising:
a surface functional layer;
a Fresnel lens layer, located on a side of the surface functional layer; wherein the Fresnel lens layer comprises a plurality of lens units, the plurality of lens units are arranged in concentric arcs that expand in sequence along a radial direction; the lens units comprise lens surfaces tilted relative to a plane where the surface functional layer is located; and
a reflection layer, at least covering the lens surfaces of the lens units;
wherein an inclination angle of the lens surface of each of the lens units is sufficient to reflect light, emitted by a projection device to the reflection layer on the lens surface, toward a viewer;
each of the lens units is axially symmetrically distributed, a symmetry axis of each of the lens units is perpendicular to a horizontal direction, and circle centers of the lens units are located on a straight line where the symmetry axis is located; the inclination angle of the lens surface of at least one lens unit in the plurality of lens units at a first location is greater than the inclination angle of the lens surface of at least one lens unit in the plurality of lens units at a second location, and a distance from the first location to the symmetry axis is greater than a distance from the second location to the symmetry axis.

2. The projection screen according to claim 1, wherein the circle center of each of the lens units is not located in the projection screen, and inclination angles of the lens surfaces of all the lens units comprised in the projection screen increase as vertical distances from the lens surfaces to the symmetry axis increase.

3. The projection screen according to claim 2, wherein a variation of inclination angles of the lens surface of a same lens unit satisfies a sine function.

4. The projection screen according to claim 3, wherein inclination angles of the lens surface of each of the lens units increase along the radial direction as a radius of the lens unit increases.

5. The projection screen according to claim 4, wherein an amplitude of the sine function satisfied by the inclination angle of the lens surface of each of the lens units increases as the radius of the lens unit increases.

6. The projection screen according to claim 5, wherein an amount of the variation of the inclination angles of the lens surface of the same lens unit is greater than 0 and less than or equal to 2.25°.

7. The projection screen according to claim 6, wherein the amount of the variation of the inclination angles of the lens surface of the lens unit increases as a size of the projection screen increases.

8. The projection screen according to claim 1, wherein inclination angles of the lens surfaces of the same lens unit at locations where the lens surfaces are symmetrical to each other about the symmetry axis are equal.

9. The projection screen according to claim 1, wherein the reflection layer is a wavelength selection based reflection layer, and a reflectivity of the wavelength selection based reflection layer to projection light emitted by the projection device is greater than a reflectivity of a light in other bands;
the wavelength selection based reflection layer has an equal thickness along a direction perpendicular to the lens surface.

10. The projection screen according to claim 9, wherein inclination angles of the lens surface of each of the lens units increase along the radial direction as a radius of the lens unit increases;
a thickness of the wavelength selection based reflection layer along a direction perpendicular to a plane where the projection screen is located increases as the radius of the lens unit increases.

11. The projection screen according to claim 1, wherein any light-transmitting film layer in the projection screen comprises a low-valent oxide; the low-valent oxide is used to reduce a transmittance in a visible light band.

12. The projection screen according to claim 11, wherein the low-valent oxide is a metal low-valent oxide;
an absorption capacity of the low-valent oxide to the visible light band decreases with an increase of oxygen content.

13. The projection screen according to claim 11, wherein the reflection layer is a wavelength selection based reflection layer, and a reflectivity of the wavelength selection based reflection layer to projection light emitted by the projection device is greater than a reflectivity of a light in other bands;
the wavelength selection based reflection layer comprises:
a light reflective layer; and
at least one film layer group, located on a side of the light reflective layer facing the surface functional layer; wherein the at least one film layer group is stacked;
wherein, the film layer group comprises:
a translucent layer, located on a side close to the surface functional layer; and
a light-transmitting medium layer, located between the translucent layer and the light reflective layer; wherein a product of a refractive index and a thickness of the light-transmitting medium layer satisfies a condition for causing an outgoing light of the projection device to resonate.

14. The projection screen according to claim 13, wherein the light-transmitting medium layer comprises the low-valent oxide.

15. The projection screen according to claim 13, wherein the light-transmitting medium layer comprises the low-valent oxide and a complete oxide.

16. The projection screen according to claim 15, wherein the light-transmitting medium layer comprises a first medium layer and a second medium layer stacked;
wherein the first medium layer is made of the low-valent oxide and the second medium layer is made of the complete oxide; or,
the first medium layer is made of the complete oxide and the second medium layer is made of the low-valent oxide.

17. The projection screen according to claim 14, wherein the low-valent oxide is one of Nb₂O₅₋ₓ, TiO_{2-y}, or Ta₂O_{5-z};
wherein 0<x<5, 0<y<2, 0<z<5.

18. The projection screen according to claim 13, wherein the translucent layer is a laminated structure formed by at least one metal selected from aluminum, niobium, silver and titanium; and a thickness of the translucent layer ranges from 2 nm to 20 nm;
a material of the light reflective layer is aluminum, aluminum alloy, silver or silver alloy; a thickness of the light reflective layer is greater than 50 nm;
the product of the thickness and the refractive index of the light-transmitting medium layer ranges from 1200 to 1800.

19. A projection system, comprising:
a projection device for emitting projection light; and
a projection screen, located on a light-emitting side of the projection device;
wherein the projection device is an ultra-short-throw laser projection device; the projection device comprises:
a three-color laser source device, used for emitting three-primary-color laser lights;
a light modulation component, located on a light-emitting side of the three-color laser source device, and used to modulate a laser light emitted by the three-color laser source device; and
a projection lens, located on a light-emitting side of the light modulation component;
wherein the projection screen comprises:
a surface functional layer;
a Fresnel lens layer, located on a side of the surface functional layer; wherein the Fresnel lens layer comprises a plurality of lens units, the plurality of lens units are arranged in concentric arcs that expand in sequence along a radial direction; the lens units comprise lens surfaces tilted relative to a plane where the surface functional layer is located; and
a reflection layer, at least covering the lens surfaces of the lens units;
wherein an inclination angle of the lens surface of each of the lens units is sufficient to reflect light, emitted by a projection device to the reflection layer on the lens surface, toward a viewer;
each of the lens units is axially symmetrically distributed, a symmetry axis of each of the lens units is perpendicular to a horizontal direction, and circle centers of the lens units are located on a straight line where the symmetry axis is located; the inclination angle of the lens surface of at least one lens unit in the plurality of lens units at a first location is greater than the inclination angle of the lens surface of at least one lens unit in the plurality of lens units at a second location, and a distance from the first location to the symmetry axis is greater than a distance from the second location to the symmetry axis.

20. The projection system according to claim 19, wherein the circle center of each of the lens units is not located in the projection screen, and inclination angles of the lens surfaces of all the lens units comprised in the projection screen increase as vertical distances from the lens surfaces to the symmetry axis increase.
